(19) United States
(12) Patent Application Publication
(10) Pub. No.: US 2023/0172109 A1
(43) Pub. Date: Jun. 8, 2023

(54) Produce Picking Device, System and Method

(71) Applicant: Ripe Robotics Pty Ltd, Ardmona, Victoria (AU)

(72) Inventors: Hunter Jay, Sydney, NSW (AU); Gabriel Ralph, Sydney, NSW (AU)

(21) Appl. No.: 17/912,783

(22) PCT Filed: Apr. 8, 2021
(86) PCT No.: PCT/AU2021/050325

§ 371 Date: Sep. 19, 2022

(30) Foreign Application Priority Data
Apr. 8, 2020 (AU) 2020901122

(51) Int. Cl. A01D 46/30; B25J 15/06; B25J 19/02; B25J 9/16

(52) U.S. Cl. CPC A01D 46/30; B25J 15/0616; B25J 19/023; B25J 9/1697

(57) ABSTRACT

A produce picking device comprising: one or more robotic actuators; a camera; a vacuum device; a conveyor conduit having a sealable picking effector, wherein the conveyor conduit includes a plurality of deformable lips substantially equally distributed along and between a first end and an exit aperture of the conveyor; and a controller, having a processor configured to: receive one or more images of a plant from the camera; detect, using an object detection model, the pickable object of the plant; determine a position of the pickable object relative to the camera; control the one or more robotic actuators according to the determined position; and actuate the vacuum device to sealingly engage, pick and convey the pickable object. The pickable object that is picked is incrementally conveyed and supported between the plurality of deformable lips along the conveyor conduit from the first end to the exit aperture.

### RELATED APPLICATIONS

The current application claims priority to Australian Provisional Application No. 2020901122, filed 8 Apr. 2020, the contents of which is herein incorporated by reference in its entirety.

### FIELD

The present invention relates to a produce picking device, a method of operating the same, and a system.

### BACKGROUND

Hiring staff to pick produce, such as fruit from fruit trees, is becoming problematic in particular locations. In some locations, the labour cost of picking is a major cost in the process of growing produce. Research has been invested into autonomous or semi-autonomous solutions to pick such objects from plants. Various problems have been encountered. Robotic solutions with gripable end actuators may be undesirable due to the pressure that can be applied to the produce when accelerating quickly enough to cleanly break away the produce from the plant, and the inability to cleanly grip the produce and avoid damage to the plant, for example by gripping leaves and/or twigs. Attempts have been made to utilise vacuum devices to pick fruit from trees, but have so far largely relied on secondary, alternative systems of fruit conveyance to transport the fruit away from the end-effector, or have required very high airflow to move fruit. In instances where very high airflow has been used to convey fruit, the speed of the fruit can increase substantially under the force created by the vacuum device resulting in the fruit potentially impacting a surface at high speed when being collected, thereby risking damage to the fruit.

### SUMMARY

It is an object of the present invention to address one or more of the above disadvantages, or at least provide a useful alternative.

In a first aspect, there is provided a produce picking device comprising: one or more robotic actuators; a camera coupled to the one or more robotic actuators; a vacuum device; a conveyor conduit, in fluid communication with the vacuum device, having a first end including a sealable picking effector coupled to the one or more robotic actuators, and an exit aperture, wherein the sealable picking effector includes an entry aperture for receiving a pickable object, wherein the conveyor conduit includes a plurality of deformable lips that are substantially equally distributed between the first end and the exit aperture; and a controller, electrically coupled to the camera, the one or more robotic actuators, and the vacuum device, wherein the controller comprises a memory having stored therein executable instructions and a processor, coupled to the memory, wherein execution of the executable instructions causes the processor to: receive one or more images of a plant from the camera; detect, using an object detection model stored in memory and the one or more images, the pickable object of the plant; determine a position of the pickable object relative to the camera; control the one or more robotic actuators according to the determined position; and actuate the vacuum device to sealingly engage, pick and convey the pickable object from the plant, wherein the pickable object that is picked is received via the entry aperture of the sealable picking effector and incrementally conveyed and supported between the plurality of deformable lips along the conveyor conduit from the first end to the exit aperture to exit the conveyor conduit for collection in a bin.

In certain embodiments, the conveyor conduit includes a plurality of conduit segments, wherein each deformable lip is provided by a conduit segment of the plurality of conduit segments, each conduit segment having a hole, wherein the plurality of conduit segments are coupled together to align respective holes to thereby define the conveyor conduit.

In certain embodiments, each conduit segment of the plurality of conduit segments includes a sleeve extending rearwardly from the respective deformable lip and a stiffener located adjacent to and within the respective sleeve, wherein a tail portion of a sleeve of one conduit segment of the plurality of conduit segments couples about and sealingly engages with a respective sleeve supported by a respective stiffener of a neighboring conduit segment of the plurality of conduit segments.

In certain embodiments, the conveyor conduit includes a plurality of conduit segment fasteners, wherein each conduit segment fastener is configured to maintain sealing engagement between neighboring conduit segments of the plurality of conduit segments.

In certain embodiments, the deformable lip and the sleeve of each conduit segment are integrally formed and made of an elastic material to allow neighboring conduit segments of the conveyor conduit to move relative to each other whilst coupled together by the respective conduit segment fastener.

In certain embodiments, each deformable lip includes a substantially frustoconical projection extending rearwardly from the sleeve forming an acute angle with respect to a central axis of the conduit segment.

In certain embodiments, the entry aperture of the sealable picking effector is defined by a nozzle deformable lip.

In certain embodiments, the nozzle deformable lip is thicker in cross-section compared to a cross-section of each deformable lip of the plurality of deformable lips of the conveyor conduit.

In certain embodiments, the nozzle deformable lip is thicker in cross-section compared to a cross-section of a next deformable lip of the plurality of deformable lips in a conveyance direction along the conveyor conduit.

In certain embodiments, the entry aperture of the sealable picking effector is configured such that when the pickable object blocks the entry aperture, the vacuum device creates a pressure difference imparting a force on the pickable object in a conveying direction.

In certain embodiments, the vacuum device is coupled to a second end of the conveyor conduit, wherein the exit aperture is located between the first and second end.

In certain embodiments, spacing between each deformable lip of the plurality of deformable lips is between 10 millimeters to 100 millimeters.

In certain embodiments, the vacuum device is configured to generate a pressure difference between 50 millibars and 350 millibars.

In certain embodiments, the vacuum device is configured to generate an airflow of 200 cubic meters per hour to 800 cubic meters per hour.

In certain embodiments, the produce picking device comprises at least two robotic actuators that are movable with a common drive such that a vertical movement of one robotic actuator coincides with an inverse vertical movement of another robotic actuator.

In certain embodiments, the one or more actuators include a first linear actuator operable along a first axis, a second linear actuator operable along a second axis orthogonal to the first axis, and one or more rotational actuators operable about a respective axis, wherein the processor is configured to actuate one or more of the first and second linear actuators, and the one or more rotational actuators according to the determined position of one of the pickable object of the plant.

In certain embodiments, the one or more actuators further include a further linear actuator operable along a further axis parallel to but spaced from the first axis, and wherein the first and further linear actuators are coupled to the sealable picking effector and are differentially drivable so as to change an angle between the sealable picking effector and the first axis or further axis.

In certain embodiments, the produce picking device further comprises a bin fill sensor for generating a signal indicative of a level of filling of the bin, wherein the processor is configured to: receive a fill signal indicative of the level of filling of the bin; compare the level of filling of the bin to a threshold fill level stored in the memory; and stop actuating the one or more robotic actuators and the vacuum device to pick a further pickable object in response to the level of filling of the bin being equal to or exceeding the threshold fill level.

In certain embodiments, the bin is supported by a movable platform, wherein the movable platform is coupled to a platform actuator, wherein the processor is configured to actuate the platform actuator to move the platform in response to the fill signal.

In certain embodiments, the processor is configured to actuate the platform actuator to: effect downward movement of the movable platform in response to the fill level approaching the threshold fill level.

In certain embodiments, the processor is configured to actuate the platform actuator to: effect downward movement of the movable platform based on a predetermined function of the fill signal so as to maintain a distance between the fill level of the bin and the exit aperture within a predetermined range.

In certain embodiments, the platform actuator is a motor mounted to the base for driving the movable platform, wherein the produce picking device further comprises: a base for supporting the one or more robotic actuators; and a transmission between the motor and the movable platform to transmit mechanical power from the motor to the movable platform, wherein the movable platform is connected to the base by a roller bracket connected to a guide rail and the transmission is connected to the movable platform adjacent the roller bracket.

In certain embodiments, the motor includes a winch and the transmission includes a pulley located vertically above the roller bracket and a cable between the roller bracket and the winch.

In certain embodiments, the base is coupled to a first and second pair of continuous tracks, wherein the body is elongate having a first end and a second end, wherein the first pair of continuous tracks are coupled to the first end of the body and the second pair of continuous tracks are coupled to a second end of the body.

In certain embodiments, the controller is configured to control actuation of the continuous tracks independently.

In certain embodiments, the produce picking device further comprises a location receiver in communication with the processor, wherein the memory has stored therein map data indicative of a plurality of scores associated with a respective plurality of map cells of a map, wherein the map represents an environment where the plant is located, each score being indicative of a degree of desirability for the produce picking device to travel to respective the map cell of the environment from a current location, wherein the processor is configured to: determine, based on a current location of the produce picking device received from the location receiver and the plurality of scores of the plurality of cells indicated by the map data, a path to move the produce picking device within the environment; and actuate a conveyance assembly of the produce picking device according to the path.

In certain embodiments, the processor is configured to rescore one or more cells of the map data according to at least one of: a user-defined path received from a user controlled remote control device in wireless communication with a communication interface of the produce picking device; feedback from one or more object detection sensors of the produce picking device; and one or more previously navigated cells.

In certain embodiments, the one or more object detection sensors comprise of at least one of: the camera; one or more ultrasonic sensor; and one or more LIDAR sensors.

In certain embodiments, the produce picking device further comprises: one or more further sensors for assessing the pickable object after picking; and wherein the processor is configured to: receive assessment data from the one or more further sensors; receive a current location of the produce picking device from the location receiver; and store in the memory a record indicative of the assessment data, the current location of the produce picking device, the detected position of the respective pickable object on the plant, and a timestamp.

In another aspect, there is provided a system for picking produce, comprising: a produce picking device configured according to the first aspect; and a portable processing system configured to: capture input data indicative of at least one of: one or more locations within the environment of the one or more plants; and a desirability for the produce picking device to travel within a portion of the environment; and facilitate transfer of the map data, based on the input data, to the produce picking device.

In certain embodiments, the portable processing system includes a location receiver, wherein the one or more locations of the one or more plants are determined using the location receiver of the portable processing system.

In certain embodiments, the portable processing system is configured to: receive, via an input device, a produce picking command; and wirelessly transfer, to the controller of the produce picking device, the produce picking command.

In certain embodiments, the system further comprises a remote control device, wherein the remote control device is configured to: receive, via an input device of the remote control device, a produce picking command; and wirelessly transfer, to the processor of the produce picking device, the produce picking command.

In a further aspect thee is provided a system for picking produce, comprising: a produce picking device configured according to the first aspect; and a remote control device configured to: receive, via an input device of the remote control device, a produce picking command; and wirelessly transfer, to the processor of the produce picking device, the produce picking command.

Other aspects and embodiments will be appreciated throughout the description of the embodiments.

### BRIEF DESCRIPTION OF DRAWINGS

One or more preferred embodiments of the present invention will now be described, by way of examples only, with reference to the accompanying drawings.

FIGS. 1A and 1B are schematics of an example of a general-purpose computer system upon which various arrangements described herein are implemented.

FIGS. 2A and 2B are schematics of an example of an embedded system upon which various arrangements described herein are implemented.

FIG. 3 is an isometric view of an example of a produce picking device.

FIG. 4 is a side elevation view of the produce picking device of FIG. 3.

FIG. 5 is a top plan view of the produce picking device of FIG. 3.

FIG. 6 is a detailed isometric view of an end effector assembly of the produce picking device of FIG. 3.

FIGS. 7A to 7C are schematic diagrams showing functionality of the end effector assembly of FIG. 6.

FIG. 8 is an isometric cross-sectional view of a mould used to produce an elastic portion of a conduit segment having a deformable lip.

FIG. 9A is a side section view of the elastic portion of the sealable picking effector and conduit segment produced by the mould of FIG. 8.

FIG. 9B is an end view of an example of a conduit section.

FIG. 9C is a perspective plan view of the conduit section of FIG. 9B.

FIG. 9D is a perspective end view of a conveyor conduit including a plurality of coupled conduit sections.

FIG. 10 is a schematic diagram showing functionality of multiple deformable lips of FIG. 9 used in series and in fluid communication with a vacuum device.

FIG. 11 is schematic diagrams showing the use of stiffeners with the deformable lips of FIG. 10.

FIG. 12 is a detailed side elevation view of a bin assembly of the produce picking device of FIG. 3.

FIG. 12A is an isometric view of an example of a produce picking device according to an alternative embodiment of the invention.

FIG. 12B is a detailed side elevation view of the bin assembly of the produce picking device of FIG. 12A.

FIG. 13A is a schematic of an example control system of a produce picking device.

FIG. 13B is a schematic of a further example control system of a produce picking device.

FIG. 14 is a schematic of a system for training and operating a produce picking device within an environment.

FIG. 15 is a flowchart representing an example method of operating a produce picking device.

FIG. 16 is a flowchart representing a further example method of operating a produce picking device.

FIG. 17 is a flowchart representing an example method of training a real-time detection model for operating a produce picking device.

FIG. 18 is a flowchart representing an example method of gathering map data for an environment for navigating the produce picking device about the environment.

FIG. 19 is a flowchart representing an example method of operating a produce picking device for picking objects from multiple regions of multiple plants.

FIG. 20 is an isometric view of another example of a produce picking device.

FIG. 21 is a side elevation view of the produce picking device of FIG. 20.

FIG. 22 is a plan elevation view of the produce picking device of FIG. 20.

FIG. 23 is an isometric view of an end effector assembly of the produce picking device of FIG. 20.

FIG. 24 is a reverse isometric view of the end effector assembly shown in FIG. 23 with the sealable end effector removed.

FIG. 25 is an isometric cross-sectional view of a mould used to produce an alternate elastic portion of a conduit segment having a deformable lip.

FIG. 26A is a side section view of the elastic portion of the conduit segment produced by the mould of FIG. 8.

FIG. 26B is an end view of an example of an end effector assembly of the conveyor conduit using the elastic portion illustrated in FIG. 26A.

FIG. 26C is a perspective view of the end effector assembly of the conveyor conduit of FIG. 26B.

FIG. 27 is an isometric view of an example of a cap attachment of the end effector assembly.

FIG. 28 is a side view of the cap attachment of FIG. 27.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or the patent applicant that such documents or devices in any way form part of the common general knowledge in the art.

Disclosed is a produce picking device for picking pickable objects, such as apples or the like, from plants, such as apple trees. The produce picking device is configured to operate autonomously, or at least semi-autonomously.

In one form, the produce picking device comprises of one or more robotic actuators, a camera coupled to the one or more robotic actuators, a vacuum device; a conveyor conduit, and a controller electrically coupled to the camera, the one or more robotic actuators and the vacuum device. The conveyor conduit is in fluid communication with the vacuum device, and has a first end including a sealable picking effector coupled to the one or more robotic actuators, and an exit aperture. The sealable picking effector includes an entry aperture for receiving a pickable object, wherein the conveyor conduit includes a plurality of deformable lips that are substantially equally distributed between the first end and the exit aperture. The controller comprises of a memory having stored therein executable instructions and a processor, coupled to the memory. Execution of the executable instructions causes the processor to receive one or more images of a plant from the camera, detect, using a object detection model stored in memory and the one or more images, a pickable object of the plant; determine a position of the pickable object relative to the camera; control the one or more robotic actuators according to the determined position; and actuate the vacuum device to sealingly engage, pick and convey the pickable object from the plant, wherein the pickable object that is picked is received via the entry aperture 453 of the sealable picking effector and incrementally conveyed and supported between the plurality of deformable lips along the conveyor conduit from the first end to the exit aperture to exit the conveyor conduit for collection in a bin.

Advantageously, the substantially equal distribution of the deformable lips between the first end and the exit aperture allow for the picked object to be incrementally conveyed between neighboring lips, thereby controlling the movement of the object within the conveyor conduit. The deformable lips inhibit the momentum of the pickable object under force exerted by the vacuum device, thereby avoiding the momentum of the object to increase to a level which could cause the produce object to bruise in a collision with a hard surface. Furthermore, the deformable lips help cushion and support the transfer of the object between neighboring lips, thereby carefully controlling the conveyance of the produce object along the conveyance conduit. It will be appreciated that the incremental conveyance of the object along the conveyor conduit refers to the cyclic increase and decrease in instantaneous velocity of the pickable object within the conveyor conduit as it successively comes into contact with each deformable lip of the conveyor conduit. As the pickable object passes through one of the deformable lips thereby increasing in speed momentarily, the pickable object comes into contact with and is cushioned by the next deformable lip under the force exerted by the vacuum device, thereby momentarily inhibiting the increase in momentum of the produce object which could lead to damage. In addition, the substantially equal distribution of the deformable lips throughout the conveyor conduit enables the velocity of the pickable object contacting the deformable lip to be substantially constant throughout the length of the conveyor conduit and similarly the velocity of the picking object passing through each deformable lip is substantially constant throughout the conveyor conduit. In one example, the spacing between each deformable lip of the plurality of deformable lips is between 10 millimeters to 100 millimeters.

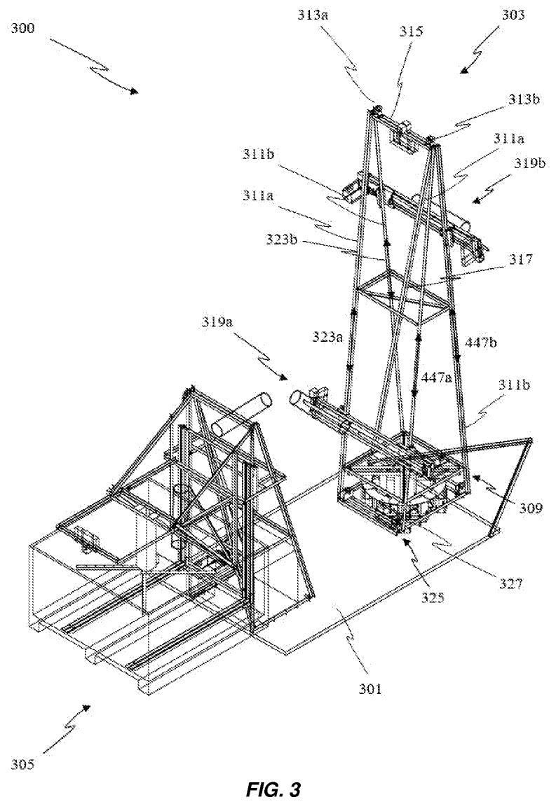

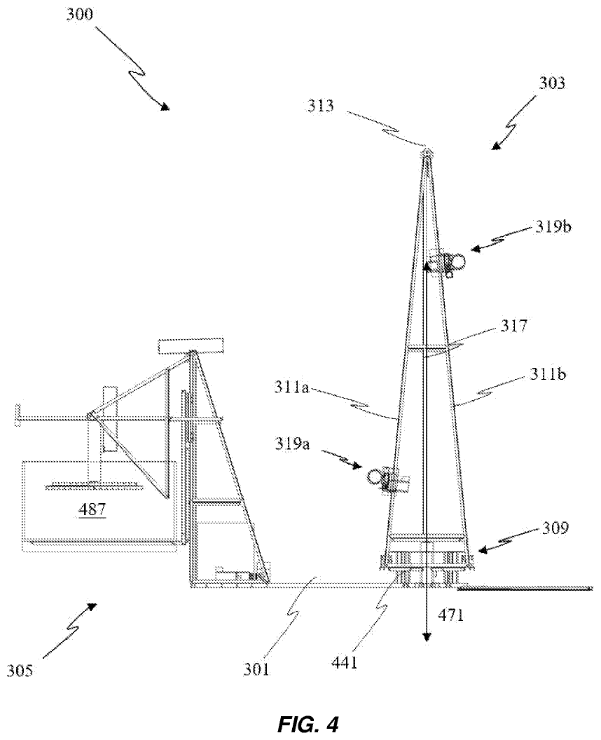

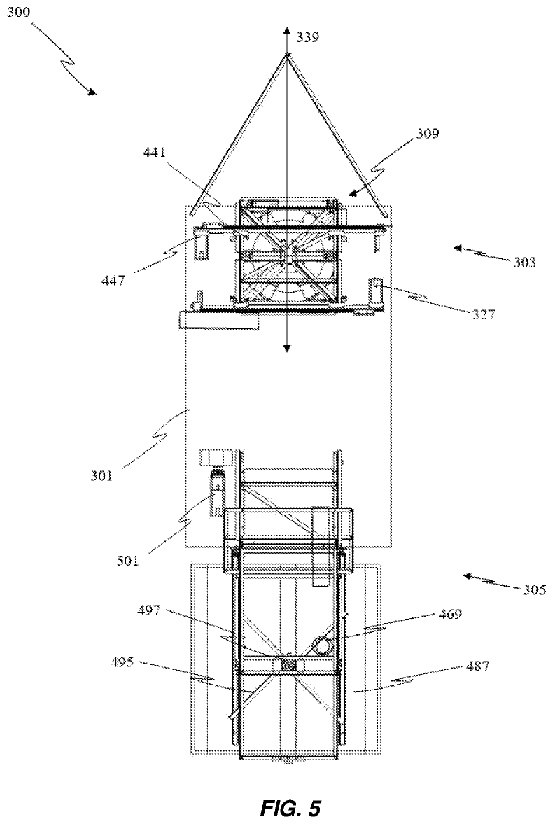

Referring to FIGS. 3, 4 and 5 there is shown an example of a produce picking device 300 comprising a base 301, such as a towable or self-powered trailer. Mounted on the base is a picking assembly 303 and a bin assembly 305. The picking assembly 303 includes a vertically elongate frame 307 having a frame base 309 and upwardly extending guide rails 311. In this embodiment, there are four guide rails 311, two guide rails 311a are parallel to each other but spaced from each other, and another two guide rails 311b are parallel to each other, but spaced from each other and angled to the guide rails 311a. Each guide rail 311a, 311b meets another guide rail 311b, 311a at a respective apex 313a, 313b of the frame 307. A first crossmember 315 extends between the two apexes 313a, 313b. A second crossmember 317 extends between the apex 313b and an edge 310 of the base 309 opposite the apex 313b.

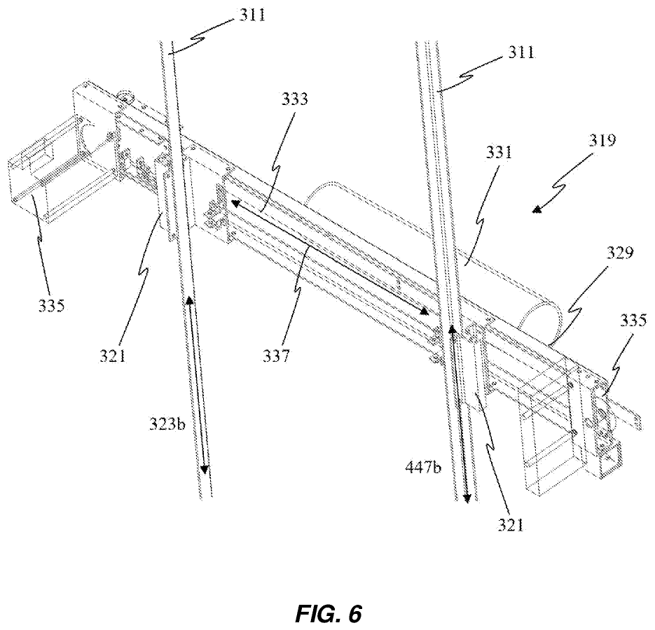

The picking assembly 303 further includes an end effector assembly 319 attached to each pair of guide rails 311a, 311b by a roller bracket 321 for each guide rail 311. A magnified view of the end effector assembly 319 of FIGS. 3, 4 and 5 is shown in FIG. 6. The end effector assembly 319 is drivable by a first robotic actuator 325 translatable along the respective guide rails 311, i.e. an axis 323a, 323b. In this embodiment, the first robotic actuator 325 includes a chain loop (not shown) connecting the end effector assemblies 319 with a motor 327. Therefore, the end effector assemblies 319 are movable with a common drive such that a vertical movement of one end assembly 319a coincides with an inverse vertical movement of another end effector assembly 319b. The end effector assembly 319 includes one or more guide rails 329 mounted to the roller bracket 321 and extending perpendicular to the guide rails 311 to which the end effector assembly 319 is connected. An end effector 331 is connected to the guide rails 329 by a roller bracket 333 and drivable by a second robotic actuator, in this embodiment a chain drive 335 along a second axis 337 parallel to the guide rails 329.

Movement of the towable or self-powered trailer can be performed by a third robotic actuator, in this embodiment an electric motor, to provide movement along a third axis 339.

The picking assembly 303 further includes a second chain loop (not shown) connecting the end effector assemblies 319 with a second motor 447. The second chain loop is spaced from the first chain loop along the second axis 337 and adapted to drive the end effector assemblies 319 along a fourth axis 443 that is parallel to the first axis 323 but spaced therefrom along the second axis 337.

The base 309 is mounted on a rotating platform 441, which may be moved about a fifth axis 471. Movement of the rotating platform 441 is effected by a fourth robotic actuator, in this embodiment an electrically powered belt or chain drive.

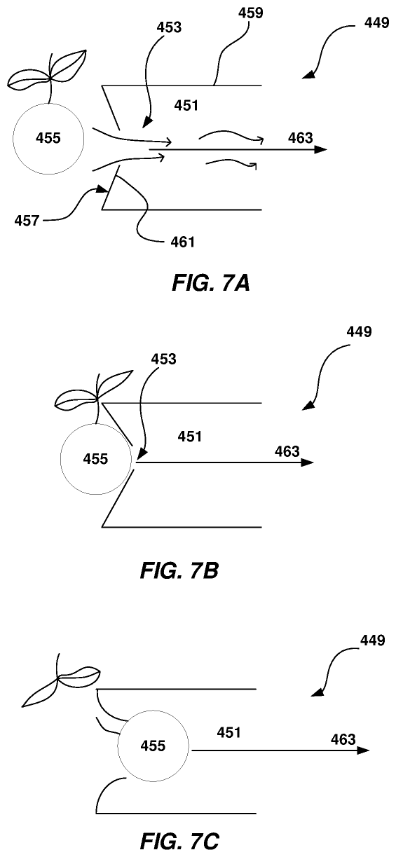

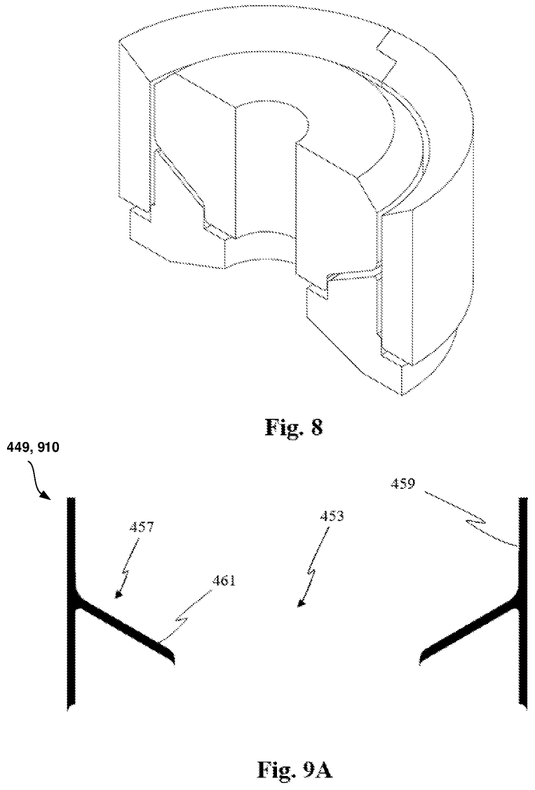

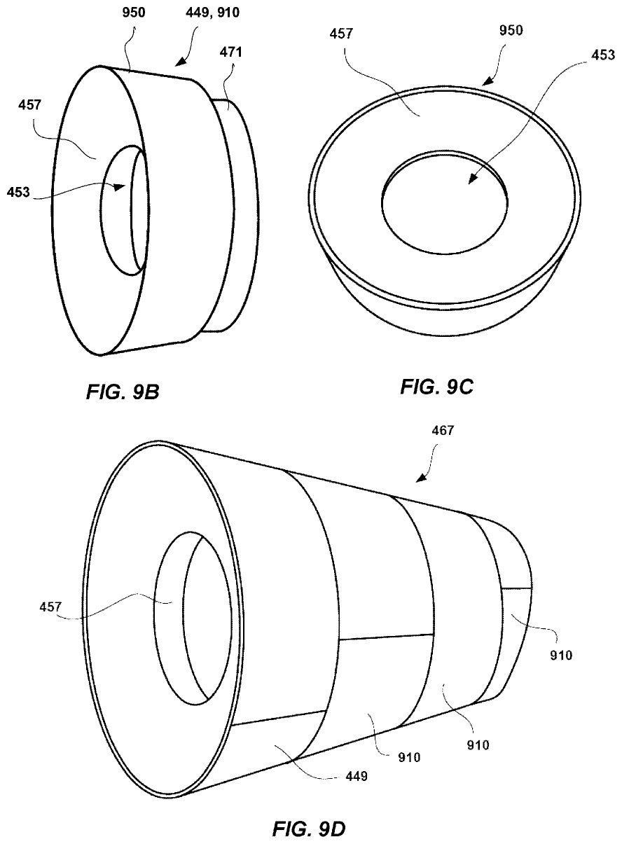

Referring to FIG. 9A, the end effector assembly 319 includes a sealable picking effector 449. The sealable picking effector 449 is generally tubular with an interior wall 459 defining a first chamber 451 that is in communication with a vacuum device, or vacuum motor 1360. Referring to FIGS. 7A, 7B and 7C, the first chamber 451 has an entry aperture 453 for receiving a pickable object 455. The entry aperture 453 is surrounded by a nozzle deformable lip 457, which preferably includes a frustroconical projection 461 from the interior wall 459 that forms an acute angle in a conveying direction 463 and with the central axis of the sleeve. The pickable object 455 is typically known to vary in size from a minimal cross-section to a maximal cross-section, particularly when the pickable object 455 is ready to be picked (i.e. fully grown), and is often subject to industry standards. As a result the entry aperture 453, being the cross-section between innermost ends of the frustroconical deformable lip 457, is dimensioned to conform to the minimal cross-section of the pickable object 455, while the total deformable cross-section of the deformable lip 457 is dimensioned to conform to the maximal cross-section of the pickable object 455.

With reference to FIGS. 9B, 9C, 10 and 11, the conveyor conduit 467 includes a plurality of conduit segments 910 which are coupled together. The plurality of conduit segments 910 can be, although not necessarily, manufactured with the same configuration as the sealable picking effector 449 and thus the same reference numbers are used to describe like features. The frontmost conduit segment 910 being the sealable picking effector 449 defines the entry aperture 453 which comes into direct contact with the pickable object 455. Subsequent coupled conduit segments 910 in the conduit 467 define a plurality of second chambers 465 that are of similar construction to the first chamber 451. Each second chamber 465 is separated from adjacent second chambers 465 by apertures 453. The second chamber 465 adjacent the first chamber 451 is separated therefrom by an aperture 453. The second chambers 465 are arranged in a chain to form the conveyor conduit 467 in the conveying direction 463.

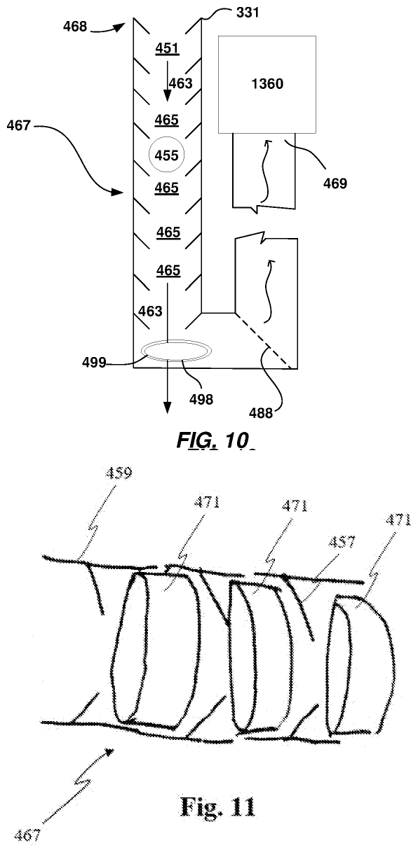

As shown in FIG. 10, the conveyor conduit 467 has an exit aperture 499 located between at an opposing second end 469 of the conduit convenor and the first end 468 including the sealable picking effector 449. The exit aperture 499 allows for the pickable object 455 to exit the conveyor conduit 467 midway along the conduit. In one form, the fruit exits the exit aperture under gravity as well as via the force exerted by the vacuum 1360. In one form, the exit aperture 499 is covered with an openable door 498 which is opened by the conveyed object 455. Airflow that continues from the location of the exit aperture 498 to the second end 469 of the conduit 467 is filtered by a filter 488. The second end 469 of the conveyor conduit 467 is connected to and in fluid communication with the vacuum motor 1360 to produce a pressure difference across the entry aperture 453 resulting in a force in the conveying direction 463 on the pickable object 455 when the pickable object 455 blocks the entry aperture 453.

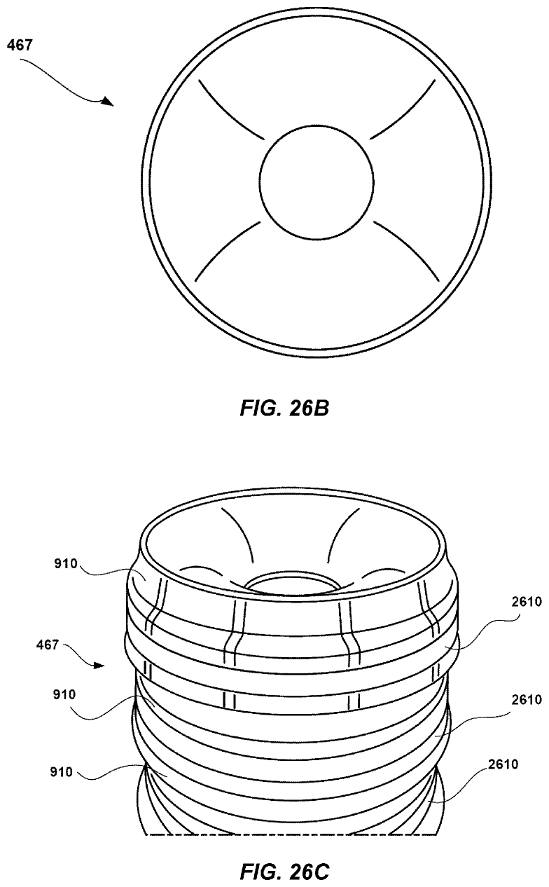

Referring more specifically to FIGS. 9B, 9C and 9D, the plurality of conduit segments 910 are coupled together to align respective apertures to thereby define a passageway for the pickable object to be conveyed through the conveyor conduit 467. Each conduit segment 910 includes a sleeve 950 extending rearwardly from the respective deformable lip 457. Each conduit segment 910 also includes a stiffener located adjacent to and located within the respective sleeve 950. A tail portion of a sleeve 950 of one of the conduit segments 910 in the conveyor conduit 467 couples about and sealingly engages with the sleeve 950 supported by a respective stiffener 471 of a rearwardly neighboring conduit segment 910 in the conveyor conduit 467. The deformable lip 457 and the sleeve 950 of each conduit segment 910 are integrally formed and made of an elastic material, such as silicone rubber. As such, the tail portion of the sleeve 950 of one conduit segment 910 can be stretched over the outer surface of the sleeve 950 of the rearwardly neighboring conduit segment 910 to couple the respective conduit sections together. However, as shown in FIG. 26, the conveyor conduit 467 can include a plurality of conduit segment fasteners 2610, such as cable ties, wherein each conduit segment fastener 2610 is configured to wrap around the outer sleeve 950 of the coupled segments 910 to maintain sealing engagement therebetween.

In one form, the interior wall 459 of each second chamber 465 is discontinuous to facilitate relative movement of the second chambers 465, thereby improving the ability of the conveyor 467 to bend without causing damage to the second chambers 465. Furthermore, as the deformable lip 457 and sleeve 950 are formed of an elastic, flexible material, the elastic, flexible material further promotes movement between the chambers defined by the coupled conduit segments 910 as shown in FIG. 11.

In one form, the stiffener 471 is embodied as a hollow cylinder formed from a material having higher stiffness than the material of the respective chamber and/or dimensioned to have a higher second moment of area than the respective chamber to resist buckling of the interior wall and also to seal the discontinuous interior wall 459. The stiffener 471 is located adjacent the interior wall 459.

In one form, the nozzle deformable lip 457 of the sealable picking effector 449 is thicker in cross-section compared to a cross-section of each deformable lip 457 of other deformable lips 457 of the conveyor conduit 467. The thicker deformable lip is advantageous for forming a sealing engagement with the pickable object when branches and leaves are proximate to the pickable object. In one form, the one or more of the deformable lips 457, other than the nozzle deformable lip 457, may be thicker in cross-section than other deformable lips 457 along the conveyor conduit 467. For example, the deformable lip 457 of one or more of the conduit segments 910 proximate to the exit aperture 499 may be thicker in cross-section than one or more conduit segment 910 distally located relative to the exit aperture 499 in order to slow the average velocity of the pickable object when approaching the exit aperture 499 so that the pickable object does not overshoot the exit aperture 499 or exit at an undesired speed. Whilst this is simply one example, one or more regions of the conveyor conduit 467 can include varying cross-sectional thicknesses of the respective deformable lips 457 to control the average velocity of the pickable object through the respective region(s).

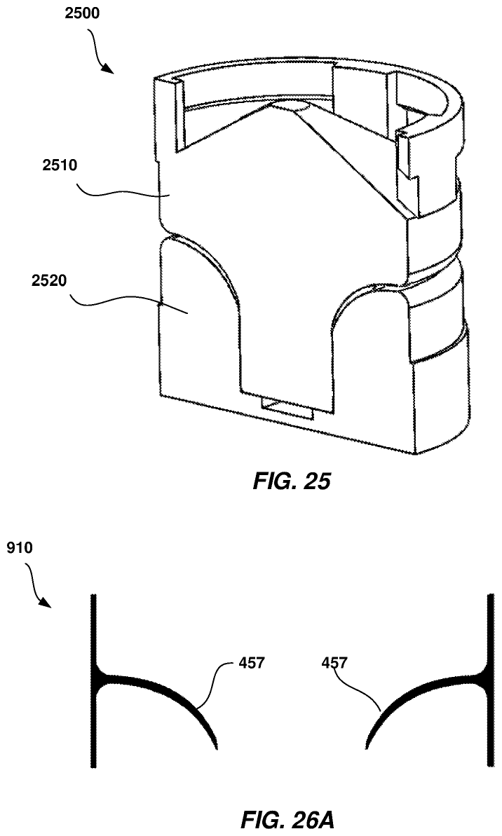

Referring to FIG. 9A there is shown a mould for manufacturing the elastic portion of the conduit segment 910. As shown in FIG. 9A, the first and second mould portions form the deformable lip 457 to have a planar profile. However, referring to FIG. 25 there is shown an alternate mould 2500 for manufacturing the elastic portion of the conduit segment 910. The engaging surfaces of the mould portions 2510, 2520 form a curved profile for the deformable lip 457 as shown in FIG. 26A. The curved and tapered profile of the deformable lip provide a superior sealable surface to sealingly engage with the pickable object. The coupling of the conduit segments 910 manufactured using the mould of FIG. 25 are shown in FIGS. 26B and 26C. As shown in FIG. 26C, a fastener is located about the tail portion of each sleeve 950 of each conduit segment 910 which maintains a sealing engagement with the rearwardly neighboring conduit segment 910 in the conveyor conduit 467.

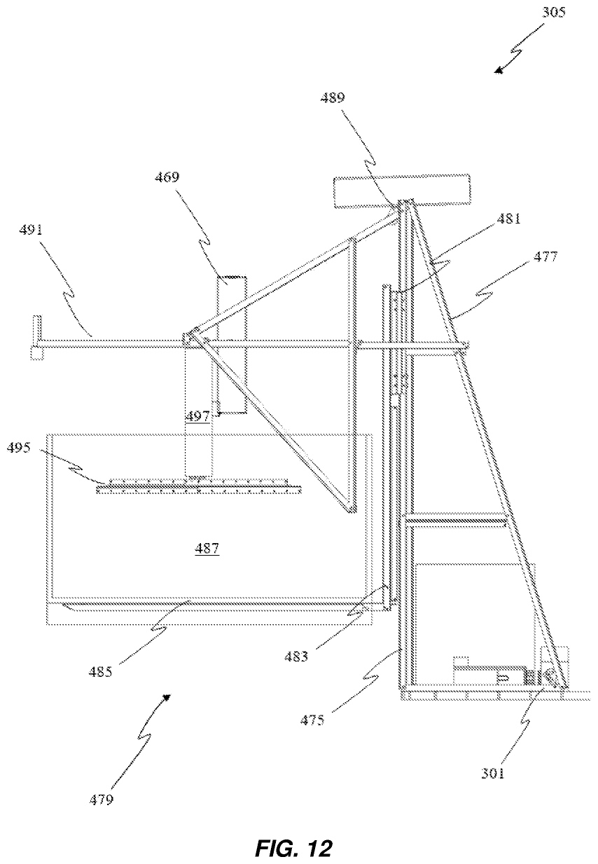

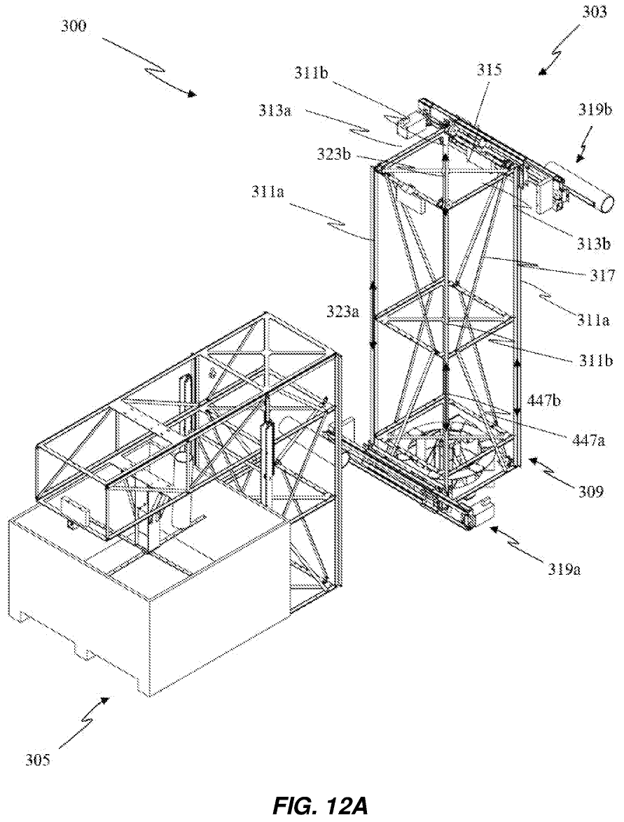

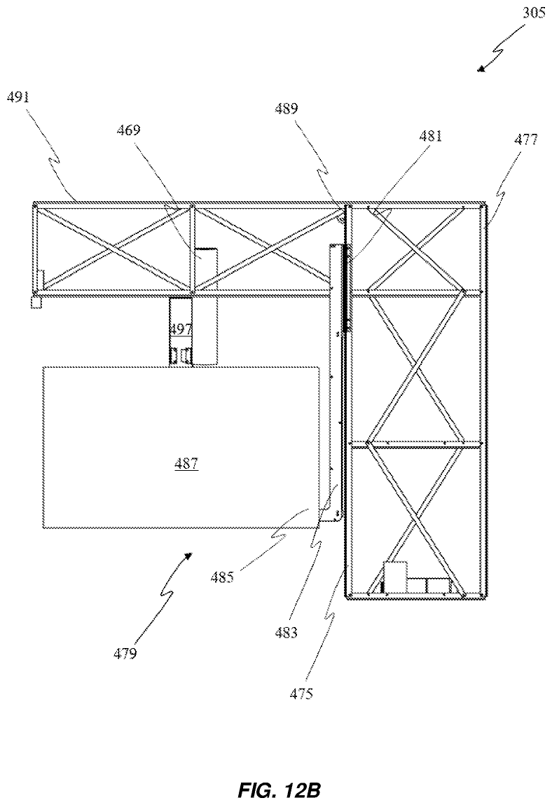

Turning now to the bin assembly 305, best seen in FIG. 12, the bin assembly 305 includes an upright 475 mounted to the base 301 that is connected at an upper end thereof to a brace member 477 which connects to the base 301 at a point between the upright 375 and the picking assembly 303. A movable platform assembly 479 is connected to a guide rail 476 of the upright 475 by a roller bracket 481 to allow for vertical movement of the platform assembly 479 along the upright 475. The platform assembly 479 has an upright 483 that connects at right angles to one or more tines 485 for supporting a bin 487. A pulley 489 is attached to the upper end of the upright 475 vertically above the roller bracket 381, and a cable (not shown) is supported by the pulley 489 and connects, at one end, to the platform assembly 479, preferably adjacent the roller bracket 481, and at another end to a tine motor 501, preferably an electrically powered winch. The cable acts as a transmission between the tine motor 501 and the platform assembly 479 to transmit mechanical power.

The bin assembly 305 further includes a cantilever 491 mounted perpendicularly to the upright 483 and extending toward the bin 487. The cantilever 491 supports the end 469 of the conveyor 467 above the bin 487 such that the pickable object 455, when ejected from the conveyor 467, falls into the bin 487. The bin assembly 305 also includes a levelling tool 493 suspended from the cantilever 491 towards the bin 487. The levelling tool 493 has several arms 495 projecting radially from a motor 497 and parallel to a floor 499 of the bin 487. Rotation of the arms 495 about a shaft of the motor 497 causes pickable objects 455 to be evenly distributed in the bin 487. The bin assembly 305 also includes a sensor for assessing the pickable object 455 after picking located at the end 469 of the conveyor 467. The bin assembly 305 also includes a bin fill sensor (not shown) for generating a signal indicative of a level of filling of the bin 487. In this embodiment, the bin fill sensor is a load cell, in another embodiment the bin fill sensor may be a light gate, in yet another embodiment the bin fill sensor may be an ultrasound or infrared distance sensor.

FIGS. 12A and 12B show an alternative embodiment of the produce picking assembly 303 and the bin assembly 305. In particular, the elongate frame 307 of the picking assembly is rectangular, rather than triangular, resulting in the first crossmember 315 being a rectangular plate element connecting the apexes 313, and the second crossmember being a brace element within the elongate frame 307. As a result, the guide rails 311 are now all parallel, as are the axes 323a, 323b, 447a, 447b. Similarly, the cantilever 491 of the bin assembly 305 includes a box lattice structure, as does the upright 483.

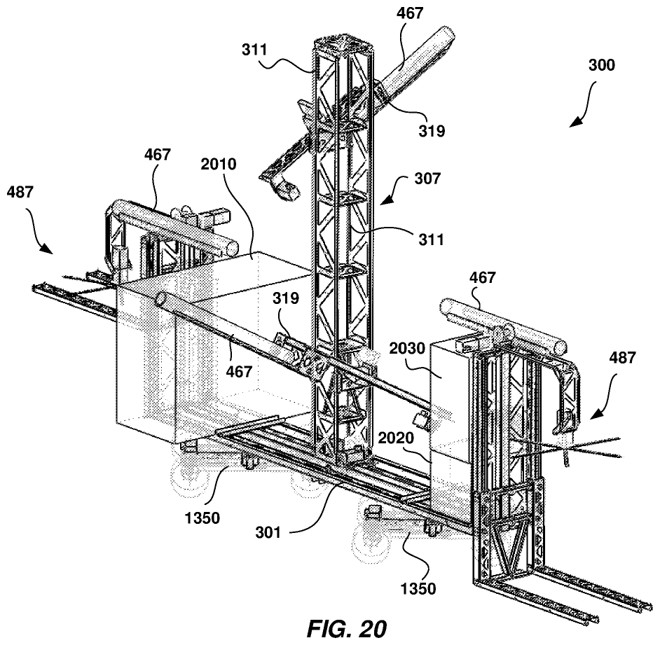

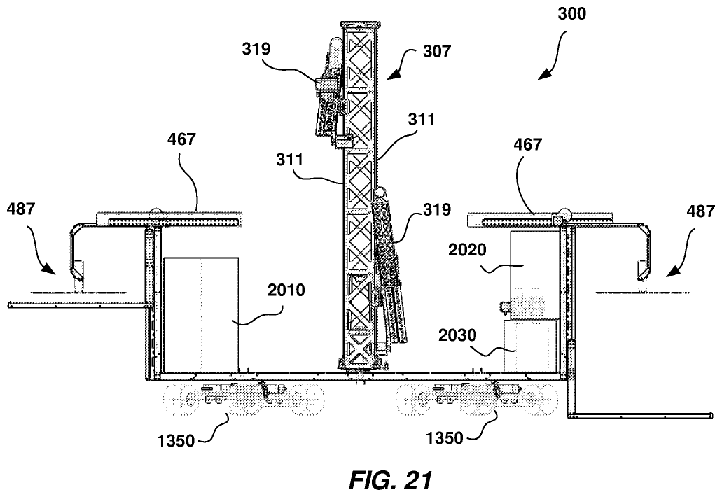

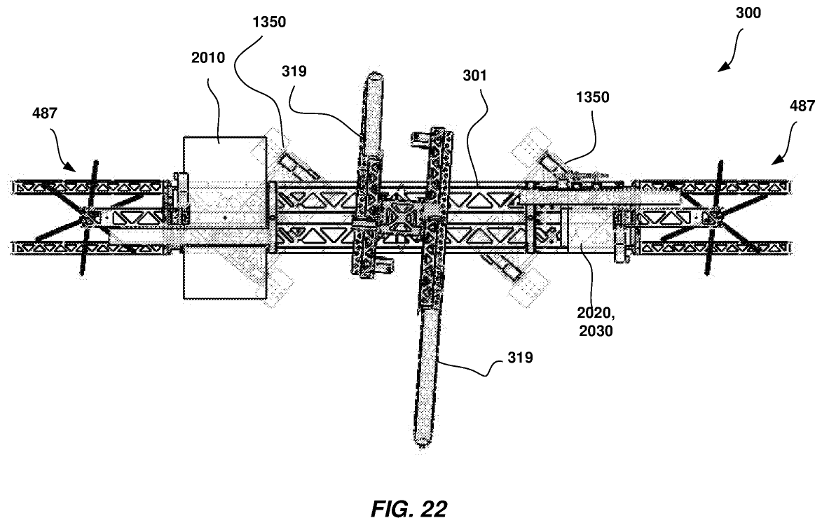

Referring to FIGS. 20, 21 and 22 there is shown a further alternate example of the produce picking assembly 303 and bin assembly 305 of the produce picking device 300. For the purposes of clarity, the portions of the produce picking device have been shown in phantom line, such as the conveyance arrangement of the produce picking device 300. Similarly to FIGS. 12A and 12B, the elongate frame 307 of the produce picking assembly has rectangular prism profile. As a result, the guide rails 311. As shown in FIGS. 20, 21 and 22, the base of the produce picking device 300 can support a plurality of cabinets 2010, 2020, 2030 for housing various components of the produce picking assembly. For example, the produce picking assembly can include one or more cabinets 2010, 2020, 2030 for housing electrical equipment, such as the controller, the vacuum device, and one or more power sources such as a generator and/or one or more batteries.

In one form, the produce picking device 300 can include a conveyance assembly 1350 provided in the form of a plurality of continuous tracks supporting the produce picking assembly. Pairs of continuous tracks located at opposing first and second ends of the body of the produce picking device can be independently controlled by the controller to allow ease of rotation thereof.

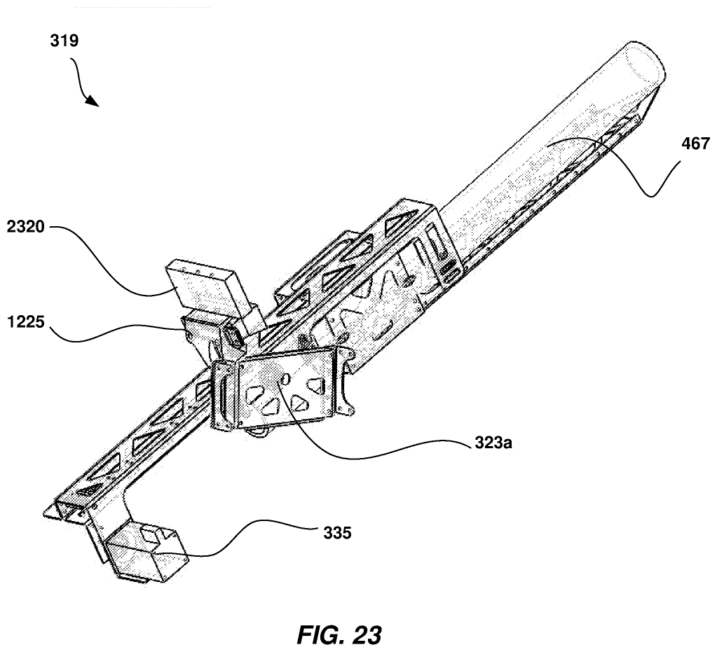

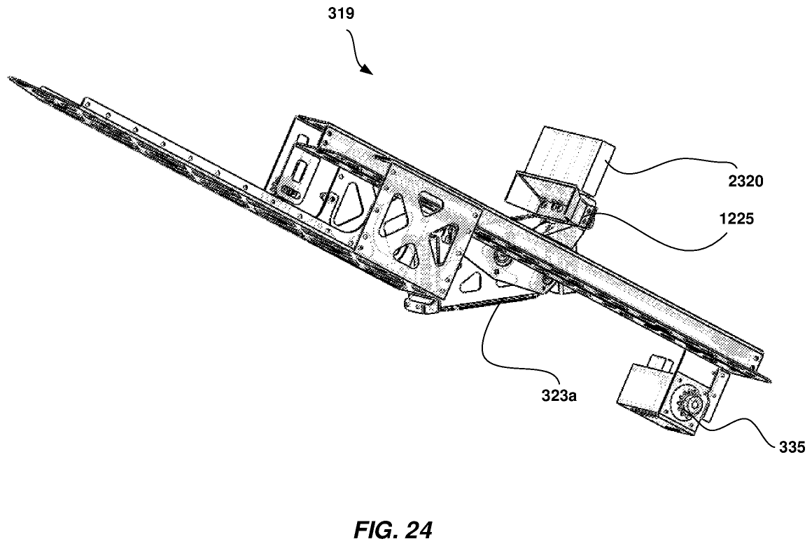

As shown in FIGS. 20 to 22, the produce picking assembly can include a plurality of end effector assemblies 319. Referring to FIGS. 23 and 24 there is shown magnified views of the end effector assembly isolated from the remainder of the produce picking device 300. As shown in FIGS. 23 and 24, the camera 1325 and a light 2320 are supported upon the frame of the end effector assembly for capturing the one or more images for the controller to detect the one or more pickable objects. The end effector assembly 319 attaches to each guide rail 311 by a roller bracket 321 via a mounting plate 321a. The end effector assembly 319 is drivable by a first robotic actuator 325 translatable along the respective guide rails 311. In this embodiment, the first robotic actuator 325 includes a chain loop connecting the end effector assemblies 319 with a motor 327. The end effector assembly 319 includes one or more guide rails 329 mounted to the roller bracket 321 and extending perpendicular to the guide rails 311 to which the end effector assembly 319 is connected. An end effector 331 is connected to the guide rails 329 by a roller bracket 333 and drivable by a second robotic actuator, in this embodiment a chain drive 335 along a second axis 337 parallel to the guide rails 329. The end effector assemblies 319 are movable with a common drive such that a vertical movement of one end assembly 319a coincides with an inverse vertical movement of another end assembly 319b.

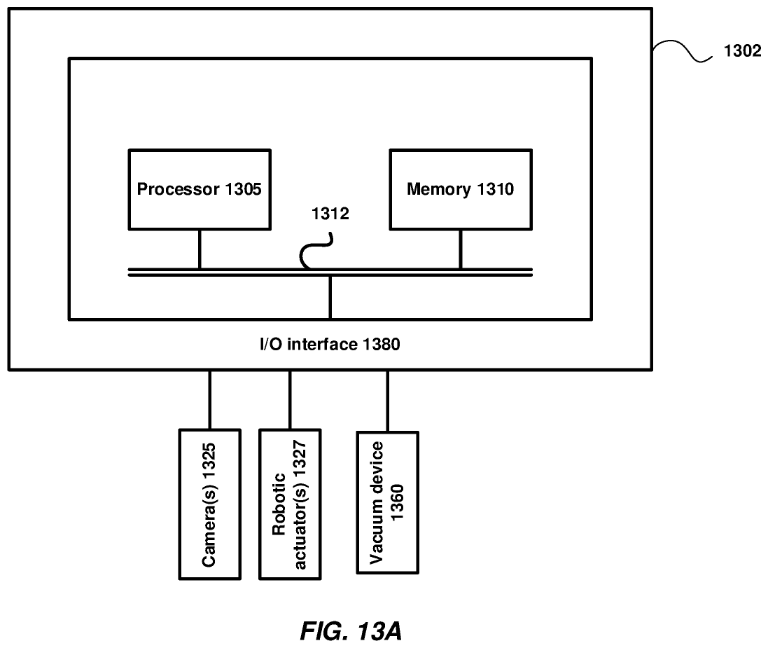

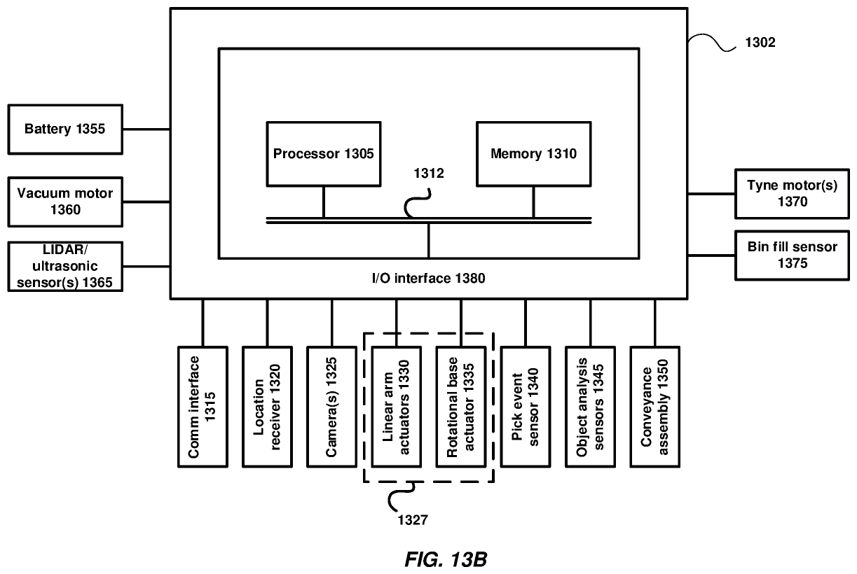

Referring to FIG. 13A there is shown an example of a control system and a plurality of electrically controllable peripheral components of the produce picking device 300. In particular, the control system 601 comprises of a controller 1302 having a processor 1305, a memory 1310, and an input/output (i/o) interface 1380 coupled together via a bus 1312. The controller 1302 can be provided in the form of embedded controller 202 as discussed above. Electrically coupled to the i/o interface of the controller are one or more robotic actuators, one or more cameras which are coupled to at least one of the one or more robotic actuators, and one or more vacuum devices.

Execution of the executable instructions stored in the memory of the control system depicted in FIG. 13A of the produce picking device 300 causes the processor 1305 to receive one or more images of a plant from the camera. The processor 1305 is further configured to detect, using a real-time object detection model stored in the memory, one or more pickable objects of the plant. The processor 1305 is further configured to determine a position of each detected pickable object relative to the camera. The processor 1305 is further configured to control the one or more robotic actuators according to the determined position to attempt to pick and convey each detected pickable object from the plant.

Referring to FIG. 13B there is shown a more specific schematic of a further example of the control system. In particular, the control system of FIG. 13B includes the same components and is coupled to the same peripheral devices as discussed in relation to 13A. However, the i/o interface is coupled to further peripheral devices. The further peripheral devices comprise of a communication interface 1315, a location receiver 1320, one or more cameras 1325, a rotational actuator 1335, such as the fourth robotic actuator, being a belt drive or chain drive, a pick event sensor 1340, one or more downstream object analysis sensors 1345, one or more wheel motors of one or more conveyance assemblies 1350, a vacuum motor 1360, one or more tine motors 1370, and a bin fill sensor 1375.

As shown in FIG. 13B, a power source such as a battery is electrically coupled to the controller 1302. It will be appreciated that the battery may be electrically coupled to one or more of the peripheral components connected to the control system. In one form, the produce picking device 300 may include a plurality of batteries to distribute electrical power between peripheral components.

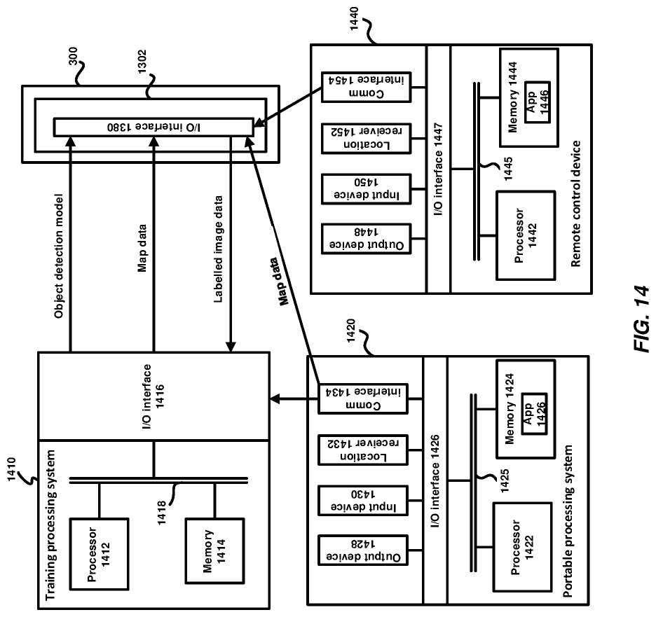

Referring to FIG. 14 there is shown a schematic of an example system. The system comprises the produce picking device 300, a training processing system 1410, and a portable processing system 1420.

The portable processing system 1420 can be a smartphone device, laptop, tablet processing system or the like. The portable processing system 1420 can be provided in the form of the computer system 100 which includes an input device 1430 and an output device 1428. The portable processing system 1420 includes a processor 1422, a memory 1424 having stored therein a computer program application 1426, a location receiver 1432 and a communication interface 1434, such as a wireless communication interface, coupled together via a bus 1426. The portable processing system 1420 can wirelessly communicate with the training processing system 1410 via the communication interface 1434 via a computer network.

In use, a user can launch the application 1426 on the portable processing system 1420. An image, such as a satellite image, of an environment, such as a farm, may be presented via the output interface 1428 of the portable processing system 1420. A boundary of the environment, such as a property boundary, may be presented via the user interface. The user can interact with the user interface to adjust the boundary of the environment which the produce picking device 300 can operate therewithin. A cell-like structure including a plurality of cells is overlayed over the satellite image. The area of each cell can be predefined in settings stored memory of the user application 1426. As a user can walk around an environment, such as the farm having located thereon on a plurality of plants with pickable objects, the application 1426 can highlight a cell on the output interface based on a current location received from the location receiver 1432. The output interface 1428 can present one or more user interface elements to provide input indicative of a desirability or undesirability of the produce picking device 300 travelling within the respective cell. In one form, the user may simply select from a first button indicating that the current location is desirable and a second button indicative that the current location is undesirable. Alternatively, the user may be presented with an interactive element to select from various levels of desirability or undesirability of the current location for the produce picking device 300. For example, a slider user interface element may be presented within the application via the output device 1428, wherein the user can move a sliding indicator to the left to indicate a level of undesirability of the current location and to the right to indicate a level of desirability of the current location. The portable processing system 1420 can transfer the user input cell data to the training processing system 1410 for forwarding to the produce picking device 300 or to the controller 1302 of the produce picking device 300 for storage in memory 1310.

The training processing system 1410 can be provided in the form of the computer system 100. In one form, the training processing system 1410 can be a laptop processing system or a desktop processing system. Alternatively, the training processing system 1410 can be provided in the form of a cloud server which can provide flexible processing resources for training the object detection model. The portable processing system 1420 can wirelessly communicate with the produce picking device 300 via the communication interface via a network or a wired communication medium. The training processing system 1410 includes a processor 1412, a memory 1414, and an input/output device 1416 coupled together via a bus 1418.

The training processing system 1410 is configured to train an object detection model. The object detection model can be a deep neural network model. In one form, the object detection model can be provided in the form of a real-time object detection model such as YOLOv3 as disclosed by Redmon et al., 2018, ‘YOLOv3: An Incremental Improvement’, University of Washington. It will be appreciated that other models can be used. The training processing system 1410 can train the object detection model using a training dataset comprising of a plurality of images labelled with a location of one or more pickable objects in each image.

In one form, the system can further comprise of a remote control device 1440 which can be provided in the form of the computer system 100. In a specific form, the remote control device 1440 can be a portable processing system 1420 such as a smartphone, tablet processing system or laptop. The remote control device comprises a processor 1442, a memory 1444, an i/o interface 1426 which has coupled thereto an output device 1448, an input device 1450, a location receiver 1452, and a wireless communication interface 1454, coupled together via a bus 1447. The remote control device 1440 has stored in memory 1444 an application 1446 which the user can interact therewith using the input device 1450 to wirelessly communicate commands to the produce picking device 300.

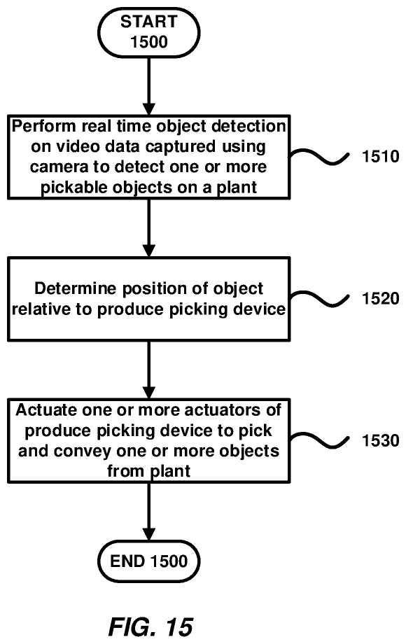

Referring to FIG. 15, there is shown a method 1500 performed by the produce picking device 300. At step 1510, the method includes the controller 1305 of the controller 1302 of the produce picking device 300 performing real-time object detection on image data captured using the camera to detect one or more pickable objects on a plant. At step 1520, the method includes the controller 1305 of the produce picking device 300 determining a position of each detected object in the one or more images relative to the produce picking device 300. At step 1530, the method includes the controller 1305 of the produce picking device 300 actuating the one or more actuators of the produce picking device 300 to attempt to pick the one or more objects from the plant.

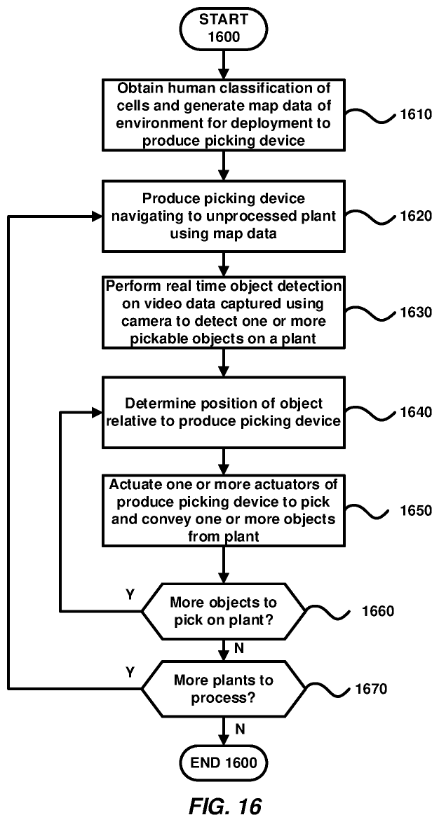

Referring to FIG. 16, there is shown a further method performed by the system of FIG. 14. In particular, at step 1610, the method includes obtaining human input data of the environment and generating map data of the environment for deployment to the produce picking device 300.

At step 1620, the method includes navigating the produce picking device 300 to an unprocessed plant using the map data. One or more records are stored in memory indicative of a processing status of the respective plant (i.e. processed meaning the produce picking device 300 has attempted to pick all detected pickable objects; unprocessed meaning the produce picking device 300 has not attempted to pick all detected pickable objects). The map data is indicative of a location of each plant to be processed within the environment. Furthermore, the map data is indicative of a plurality of cost factors for each cell to enable the controller 1305 of the produce picking device 300 to determine a respective cost (i.e. an undesirability score) for the produce picking device 300 to travel a particular path through the area. The controller 1305 of the produce picking device 300 is configured to determine a cost for each cell. The controller 1305 is then configured to determine a least cost path to travel to one of the plants from the current location within the environment using the path finding algorithm. Possible path finding algorithms that can be used include A* and Dijkstra's algorithm. Whilst the produce picking device 300 moves throughout the environment in its approach to the selected plant for processing, the controller 1305 of the produce picking device 300 can update the cost factors and cost of each cell. As such, a new least cost path can be selected by the controller 1305 of the produce picking device 300.

In particular, the produce picking device 300 comprises of the one or more object detection sensors 1365 such as one or more LIDAR sensors and/or one or more ultrasonic sensors. In the event that feedback signals received by the controller 1302 from the one or more object detection sensors is indicative of an object blocking the path chosen by the controller 1305, a cost factor is stored in relation to respective cell wherein the cost factor may be relatively high to deter the current path to be the least cost path. Additionally or alternatively, in the event that the produce picking device 300 travels through a cell successfully without detecting an object blocking the path based on the feedback signal(s) from the one or more object detection sensors, a relatively low cost factor is stored for the respective cell(s). Additionally or alternatively, in the event that the produce picking device 300 receives navigation commands from the remote control device 1440, a relatively low cost factor is stored for the respective cell(s).

At step 1630, the method includes performing real-time object detection on one or more images received from the camera to detect one or more pickable objects on the plant. The controller 1305 determines a portion of the detected position of each detected pickable object.

At step 1640, the method includes determining a position of each detected pickable object relative to the produce picking device 300. In one form, the object detection model is a deep neural network model that is trained to output a first and second coordinate (i.e. x and y coordinate) of the position of each detected object. More specifically, the object detection model outputs a matrix, such as a 16 by 16 grid, and the first and second coordinates within each grid position, as well as a 1 or 0 indicating whether the grid contains a detected pickable object or not.

At step 1650, the method includes the controller 1302 of the produce picking device 300 actuating at least some of the one or more actuators of the produce picking device 300 to attempt to pick the one or more objects from the plant. In one form, the controller 1302 determines a specific order to pick the objects which can be determined using a path finding algorithm such as those discussed above. The controller 1302 can actuate at least some of the three linear actuators 1330 as well as the rotational actuator 1335 to move an end effector to the determined position for a respective detected object. Additionally, the linear actuators 1330 acting in the first and fourth axis may be driven differentially, or with relative velocity to one another, so as to change an angle between the sealable picking effector 449 and the first axis 323 or fourth axis 473.

Upon moving the end effector to the position of a respective object or shortly therebefore, the controller 1302 can actuate the vacuum assembly in order for the end effector to be placed in substantial sealing engagement with the pickable object. The controller 1302 can then actuate the one or more actuators to move the end effector from the determined position of the pickable object until the end effector is moved a threshold distance (e.g. 30 cm) relative to the determined position or until a pick event signal is received from the pick event sensor 1340. When the sealable picking effector 449 is adjacent the pickable object 455, the pickable object 455 perceives insubstantial forces by the air movement caused by the vacuum assembly. However, once the pickable object blocks the entry aperture 453, a pressure difference is created across the pickable object 455, which creates substantial force in the conveying direction 463 and thereby moves the pickable object 455 through the deformable lips 457 into the first chamber 451.

For example, a depth sensor located in the conveyor can detect the changing distance relative to the object, thereby being an indication of a picked object. Additionally or alternatively, a change in pressure within the end effector can be indicative of the pickable object being picked from the plant (e.g. the stem of the pickable object snaps from the plant) and travelling through a transportation conveyor toward a storage bin. Alternatively, an infrared sensor fails to receive an infrared signal from an infrared emitter as the pickable object travels through the first chamber 451 indicative of the pickable object being picked from the plant. The controller 1305 records in memory a processed status for the respective pickable object.

The first chamber 451 is dimensioned such that, when the pickable object 455 has been pulled into the first chamber 451, it is substantially in a position to block the entry aperture 453 between the first chamber 451 and the second chamber 465. Again, a pressure difference is created across the pickable object 455 by the vacuum device, which creates substantial force in the conveying direction 463 and thereby moves the pickable object 455 through the deformable lips 457 into the second chamber 465. The process repeats for the remaining second chambers 465, until the pickable object 455 is ejected at the end 469. At step 1660, the method includes the processor of the controller 1302 determining if more detected objects are to be picked from the plant. In particular, the processor reviews the status of each detected object in memory for the plant. In response to a positive determination (i.e. yes), the method proceeds back to step 1640 such that the produce picking device 300 attempts to pick the next detected pickable object. In response to a negative determination (i.e. no), the method includes the processor updating the status of the plant to processed and then proceeds to step 1670 to determine whether there are more plants in the environment that need to be processed.

When a picking operation is commenced, the bin 487 is generally empty. To reduce the fall distance of the pickable object 455, the tine motor is actuated to move the bin to a maximum height, such that the floor 499 is substantially adjacent the levelling tool 493 and/or the conveyor 467. As a plurality of pickable objects 455 are ejected by the conveyor 467 into the bin 487, the processor 1305 may receive a fill signal indicative of the level of filling of the bin 487. The processor 1305 may compare the level of filling of the bin 487 to a threshold fill level stored in the memory 1310. Finally, processor 1305 may stop controlling the end effector assemblies 319 in response to the level of filling of the bin being equal to or exceeding the threshold fill level, alternatively the processor 1305 may stop controlling the end effector assemblies to attempt to pick each remaining pickable object 455 that may have been detected at step 1660 in response to the level of filling of the bin 487 being equal to or exceeding the threshold fill level.

Alternatively, or in addition, the processor 1305 may, in response to the fill signal increasing toward the threshold fill level or exceeding the threshold fill level, actuate the winch to move the platform assembly 479 vertically downward and/or away from the levelling tool 493 and/or the end 469 of the conveyor 467. Alternatively, or in addition, the processor 1305 may actuate the winch to effect downward movement of the platform assembly 479 based on a predetermined function of the fill signal so as to maintain a distance between the fill level of the bin 487 and the end 469 of the conveyor 467, thereby maintaining the drop distance of the pickable object 455 from the conveyor 467 within a predetermined range.

At step 1640, the method includes determining if more plants are to be processed within the environment. In response to a positive determination (i.e. yes), the method proceeds back to 1620 to navigate to the next most desirable plant in the environment which has not been processed. In response to a negative determination (i.e. no), the method ends.

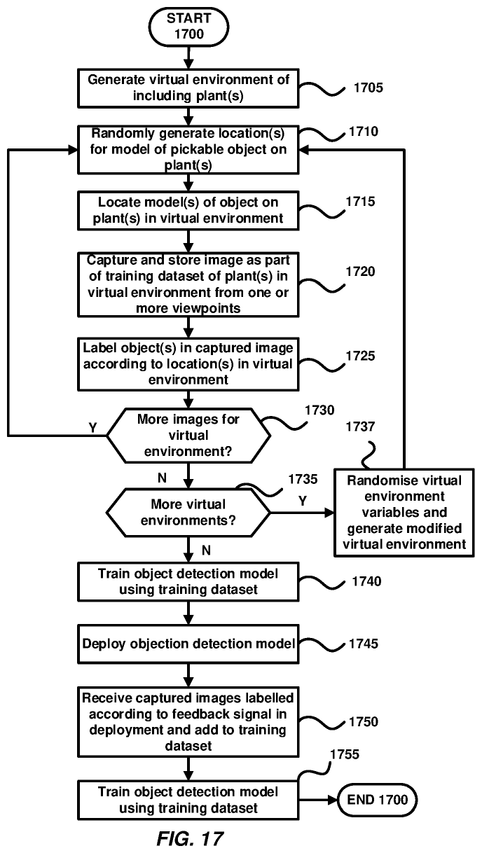

Referring to FIG. 17, there is shown a flowchart representing a method of generating images for training the real-time object detection model.

In particular, at step 1705 the method includes the training processing system generating an instance of virtual environment including one or more plants. As discussed earlier, a game engine such as the Unity game engine can be used to generate a virtual model of the environment, such as a farm. In one form, an initial instance of the virtual environment is generated using virtual environment variables to produce the instance of the virtual environment which closely resembles the environment.

As step 1710, the method includes the training processing system 1410 generating random locations to locate one or more instances of a virtual pickable object within the environment. In one form, the training processing system 1410 generates locations which are restricted to being one of the one or more plants.

At step 1715, the method includes the training processing system 1410 generating and locating instances of a virtual pickable object based on a virtual model of the pickable object within the instance of the virtual environment using the randomly generated locations generated in step 1710.

At step 1720, the method includes the training processing system 1410 capturing a plurality images (e.g. screenshots) of the instance of the virtual environment populated with the one or more instances of the virtual pickable object. The plurality of images can be captured from one or more predefined viewpoints within the virtual environment. Alternatively, the training processing system 1410 can capture the plurality of images from randomly generated viewpoints within the virtual environment. The plurality of images are stored in memory as part of a training dataset.

At step 1725, the method includes the training processing system 1410 labelling each captured image at least with the respective randomly generated position, stored in memory, of each pickable object depicted in each respective image. In addition, additional label data may be stored in association with each captured image. For example, each depicted virtual pickable object in a respective image may be labelled with one or more characteristics of the virtual instance of the pickable object which was generated. In one form, a colour of the instance of the pickable object can be labelled. Additionally, or alternatively, a variety (e.g. Granny Smith apple) can be labelled.

At step 1730, the method includes the training processing system 1410 determining if a threshold number of images have been obtained for the current virtual environment. The threshold can be stored in memory of the training processing system 1410. In the event that further images are required for the current virtual environment, the method proceeds back to 1710 to randomly generate new locations to locate new instances of the virtual pickable object within the instance of the virtual environment. In response to no further images being required for the current virtual environment, the method proceeds to step 1735.

At step 1735, the method includes the training processing system 1410 determining if more virtual environments need to be generated to capture further images for the training dataset. A virtual environment threshold and virtual environment counter may be stored in memory, wherein the training processing system 1410 performs a comparison between the respective threshold and counter to determine whether a further instance of a virtual environment is to be generated. In response to no further virtual environments needing to be generated to capture further images, the method proceeds to step 1740. In the event one or more further instances of a virtual environment are required, the method proceeds to step 1737.

At step 1737, the method includes the processing system randomly modifying virtual environment variables and generating a further instance of the virtual environment using the randomly modified environment variables. The environment variables are randomly modified over a range significantly greater than a realistic environment. The variables are modified so as to generate an unrealistic environment well beyond edge cases. In particular, environment variables that can be randomly modified include position, size, orientation, morph, and skin of environment objects excluding instance(s) of the virtual pickable object. Furthermore, environment variables such as scene lighting, obstacles, mist, haze, terrain, leaf type, tree, and fruit are randomised. Camera qualities of viewpoints such as position, angle, depth of field, focal length, position relative to a second camera (if the produce picking device 300 comprises of multiple cameras) can also be randomised. The virtual environment variables can also be modified to add artefacts, solar flares, dust, blur. Virtual environment variables such as contrast, brightness, colour palette and the like can also be randomised. The method then proceeds back to step 1710 to randomly generate locations to locate instances of the virtual pickable object within the instance of the modified virtual environment.

As explained above, in the event no further instances of a virtual environment need to be generated, a training dataset using virtually generated images has been generated and stored in memory. The method then proceeds to step 1740.

At step 1740, the method includes the training processing system 1410 training the real-time object detection model using the training dataset. In one form, the method includes the training processing system 1410 generating a plurality of real-time object detection models for various types or categories of pickable objects. For example, the produce picking device 300 may generate a generic real-time pickable object model which is able to detect a plurality of varieties of a pickable object (e.g. for apples, the generic real-time pickable object model can be trained using the entire training dataset to detect Granny Smith apples, Pink Lady apples, Fuji apples, etc) to detect multiple varieties of pickable objects. The training processing system 1410 can also train one of more real-time pickable object models specific for a variety of pickable objects. For example, the training processing system 1410 can segment the training data to have a Granny Smith training dataset, a Pink Lady training dataset, etc. which can be used by the training processing system 1410 to generate a real-time Granny Smith detection model, a real-time Pink Lady detection model, etc.

At step 1745, the method includes the training processing system 1410 deploying the real-time object detection model(s) to the controller 1302 of the produce picking device 300. The deployment can be via a computer network and can be achieved used a wireless or wired medium. Alternatively, the real-time object detection model(s) can be stored on a removable storage medium and coupled to the controller 1302 of the produce picking device 300. The one or more real-time object detection models are stored in memory of the controller 1302 of the produce picking device 300 and applied in the real-world environment as discussed throughout this document.

At step 1750, the method includes the training processing system 1410 receiving a plurality of labelled images captured from the real-world environment, such as a farm, and adding the newly received plurality of labelled images to the training dataset(s). The received plurality of images are images captured by the one or more cameras of the produce picking device 300. The plurality of images are labelled according to the position of the one or more pickable objects which was detected by the real-time object detection model. Furthermore, the received plurality of images are labelled according to whether the detected pickable object was picked based on the feedback from the one or more pick event sensors 1340. Thus, some of the plurality of images include one or more detected pickable objects which were able to be picked and some of the plurality of images have one or more incorrectly detected pickable objects or one or more correctly detected pickable objects which could not be picked (i.e. the stem could not be snapped; branches were blocking the robotic actuator path; etc). As the training dataset may be segmented, the newly received images may be segmented according to labels such as the variety of the detected pickable object when being added to one or more training datasets.

At step 1755, the training processing system 1410 retrains the one or more real-time object detection models according to the modified training dataset including labelled images captured by the one or more cameras of the produce picking device 300. This step is effectively performed similarly to step 1740 using the modified training dataset(s).

The newly trained real-time object detection models can be further deployed to one or more produce picking devices 300. Steps 1750 and 1755 can continue to be repeated over time when newly captured labelled images are acquired over operating the one or more produce picking devices 300 in real world environments.

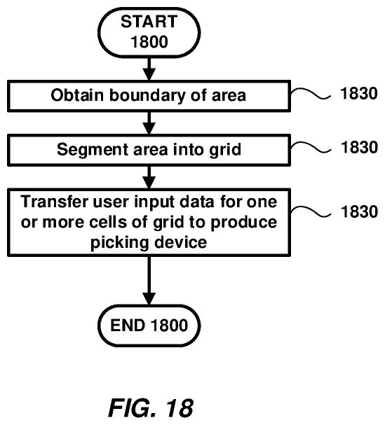

Referring to FIG. 18, there is shown a flowchart representing a method of generating map data for use by the produce picking device 300 to navigate about the environment, such as a farm, in order to perform autonomous, or at least semi-autonomous, picking of produce from plants, such as apples from apple trees.

In particular, at step 1810, the method includes a portable processing system 1420 obtaining a boundary of the environment. In one form, a satellite image may be obtained from a mapping server, such as Google Maps, which outlines a boundary of a property. Alternatively, a user can interact with the input device of the portable processing system 1420 executing the application to define the boundary of the environment.

At step 1820, the method includes the portable processing system 1420 segmenting the defined area into a grid of cells. The portable processing system 1420 segment the defined area according to a cell size setting stored in the memory of the portable processing system 1420.

At step 1830, the method includes the portable processing device 1420 receiving human classification of one or more cells. In particular, the portable processing device 1420 can receive a cost factor of one or more cells of the grid. For example, the user may simply select a desirable or undesirable button to classify a cell as being desirable or undesirable for the produce picking device 300 to travel through the cell of the environment. The portable processing device 1420 can also receive user input indicative of a location of a plant to be processed (i.e. picked) in one or more of the cells. In one form, the output device highlights the current cell of the environment which the portable processing device 1420 is located based on a received location from the location receiver 1432. As the user moves throughout the area, the respective corresponding to the location in the area is highlighted upon the output device with one or more user interface elements such as button or slider interfaces for the user to interact therewith to score the cost factor for the respective cell.

At step 1840, the method includes transferring, to the controller 1302 of the produce picking device 300, map data indicative of the boundary of the environment, the one or more locations of the respective one or more plants within the environment, and the one or more cost factors for each cell. The map data can be transferred to the produce picking device 300 using the portable processing device 1420 such as via a wireless communication medium. It will be appreciated that the map data may be transferred to the produce picking device 300 via one or more other processing systems. For example, the map data can be transferred to the training processing system 1410 and then relayed to the produce picking device 300 for use during deployment. As discussed above, the produce picking device 300 determines a cost for at least some of the cells, if not all of the cells, when attempting to navigate between locations within the environment. A plurality of cost factors can be accumulated for each cell to determine the cost of the produce picking device 300 to travel through the respective cell. The processor of the produce picking device 300 selects the least cost path using executable instructions stored in memory of the controller 1302 representing a path finding algorithm.

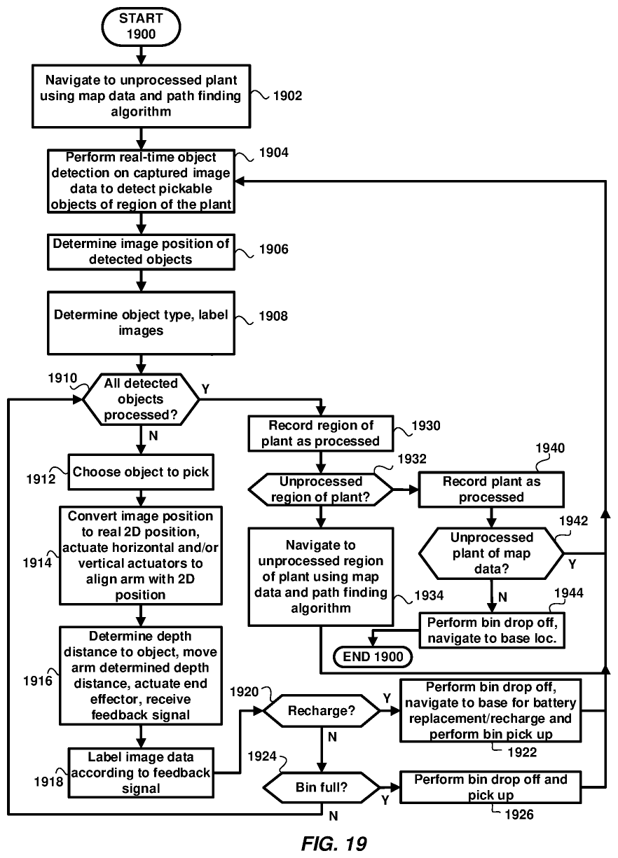

Referring to FIG. 19, there is shown a flowchart representing a method of operating the produce picking device 300.

In particular, at step 1902, the method includes navigating the produce picking device 300 using map data and the path finding algorithm stored in memory to an unprocessed plant.

At step 1904, the method includes the processor of the controller 1302 performing real-time object detection on captured image data to detect pickable objects of a region of the plant. It will be appreciated that for a large plant such as a tree, the produce picking device 300 may need to circumnavigate about the plant in order to fully process the plant. It will also be appreciated that the image data may be provided in the form of video data. In some implementations, the one or more images may be obtained from a plurality of cameras which are spaced apart to provide depth perception. As discussed above, a bounding box can be stored in memory for each pickable object which is detected by the object detection model.

At step 1906, the method includes the processor determining a position of each detected object in the image. In one form, the processor may determine a midpoint of the bounding box which is stored in memory.

At step 1908, the method includes labelling the images of the image data with a portion of the determined position of each detected object. In one form, the image data may be labelled with first and second coordinate (x and y coordinate) determined by the object detection model.

At step 1910, the method includes the processor determining whether all detected objects for the region have been processed. In particular, the processor stores in memory a list of the detected pickable objects, wherein each detected pickable object has a respective status indicative of whether the produce picking device 300 has attempted to pick the detected pickable object or not. The processor is configured to determine whether any detected objects in the list for the region have an unprocessed status. In the event that there are one or more unprocessed objects, the method proceeds to step 1912. Otherwise, the method proceeds to step 1930.

At step 1912, the method includes the processor choosing one of the detected objects to pick. The processor can select the object which is closest to the current position of the end effector. Alternatively, the processor can apply a path finding algorithm based on the unprocessed detected objects to determine n ordered picking list, wherein the next object in the ordered picking list is selected by the processor.

At step 1914, the method includes the processor converting the 2D position of the selected object in the image data to a real 2D position, and actuating the one or more of the linear actuators to adjust the vertical and horizontal alignment of the end effector with the selected pickable object.

At step 1916, the method includes the processor determining a depth distance to the object, moving the end effector according to the depth distance, actuating the end effector and receiving a feedback signal from the pick event sensor 1340. The depth distance can be determined using reference data stored in memory as discussed earlier. Additionally or alternatively, the depth distance can be determined using one or more depth sensors. Additionally or alternatively, the depth distance can be determined based on stereoscopic images captured by a plurality of cameras of the produce picking device 300. The processor can update the labelling of the with a third coordinate (i.e. z coordinate) based on the determined distance by the depth sensor(s).

At step 1918, the method includes the processor labelling the image data according to the outcome indicated by the signal received from the pick event sensor 1340. In particular, the outcome can be labelled as picked or unpicked. As discussed above, the produce picking device 300 can include a plurality of pick event sensors 1340 which can be one or more depth sensors located in the conveyor, one or more barometers and/or one or more infrared sensors. Furthermore, the method includes labelling the image data according to one or more downstream object analysis sensors 1345. In the event that the object is picked, a colour, weight and size of the picked object can be measured using the one or more object analysis sensors 1345 and stored as a label in associated with the image data of the detected object. In one form, the size of the pickable object can be determined by applying edge detection to the one or more captured images. For example, the processor searches the portion (i.e. grid cell) of the image and seek colour changes from an expected colour stored in memory of the pickable object to a colour of another portion of the plant (i.e. leaves, branches, etc) in a relatively smooth curve. Based on this process, the processor can estimate a size of the fruit based on the detected arc.

At step 1920, the method includes the processor determining whether the power source, such as the battery, of the produce picking device 300 requires recharging. The processor can determine the current level of charge and compare this value to a threshold charge value stored in memory wherein in the event that the current level of charge is less than the threshold charge value then the processor determines that the produce picking device 300 requires recharging, otherwise no recharging is required. In the event recharging is required, the method proceeds to step 1922. Otherwise, if no recharging is required, the method proceeds to step 1924.

At step 1924, the method includes the processor determining if the storage bin storing the picked objects from the plant(s) is full. In one form, the processor receives a bin fill signal from a bin fill sensor. A value indicated by the bin fill signal is compared to a bin fill threshold, wherein in the event the bin fill value is equal to or exceeds the bin fill threshold stored in memory, the processor determines that the bin is full, otherwise the bin in no full. In the event the processor determines the bin is full, the method proceeds to step 1926, otherwise the method proceeds back to step 1910.

Moving back to step 1910 described above, in the event that the produce picking device 300 has attempted to pick all detected pickable objects for the region, the method proceeds to step 1930. At step 1930, the method includes the processor recording in memory that the current region has been processed.

At step 1932, the method includes the processor determining in there are any further regions of a plant that have not been processed. The memory has stored therein the data indicative of the multiple regions of a plant. Data stored in relation to a plant has a status indicative of whether the plant has been processed or unprocessed. In the event that the current plant has not been processed (i.e. one or more further regions of the plant have not been picked), the method processed to step 1934. Otherwise, the method proceeds to step 1940.

At step 1934, the method includes the controller 1302 navigating, using the map data and the current location provided by the location receiver 1320, the produce picking device 300 to one of regions of the plant that have not been processed. This is performed in a similar manner to previous navigation steps. The method then proceeds back to step 1904.

At step 1940, the method includes the processor recording in memory a processed status for the plant. At step 1342, the method includes the processor determining whether there is one or more unprocessed plants as indicated by the map data for the environment. In the event of a positive determination, the method proceeds back to step 1904. In the event of a negative determination, the proceeds to step 1944. At step 1944, the method includes the controller 1302 navigating the produce picking device 300 to a bin drop off location to drop off the storage bin with one or more picked objects, and then the controller 1302 navigates the produce picking device 300 to a base location, such as a shed, for locating the produce picking device 300 whilst not in operational use.

As discussed above, in the event that the produce picking device 300 requires recharging as determined at step 1920, the method proceeds to step 1922. At step 1922, the method includes the controller 1302 navigating the produce picking device 300 to a bin drop off location. The controller 1302 can actuate tine actuators to lower the bin onto a ground surface or the like. The controller 1302 can then navigate the produce picking device 300 to a battery replacement/recharge location stored in the map data. In one form, an operating user may remove the low-charge battery with a recharged battery. Alternatively, the operating user may couple the low-charge battery with a recharging interface to recharge the battery of the produce picking device 300. Once the battery has been replaced or recharged, the controller 1302 navigates the produce picking device 300 to a bin pick-up location stored in the map data in memory. The controller 1302 operates tine actuators to pick-up a storage bin. The method then proceeds to step 1904.

As discussed above, in the event that the bin is full, the method proceeds to step 1926. At step 1926, the method includes the controller 1302 navigating the produce picking device 300 to a bin drop off location. The controller 1302 can actuate tine actuators to lower the bin onto a ground surface or the like. The controller 1302 further operates tine actuators to pick-up a storage bin. The method then proceeds to step 1904.

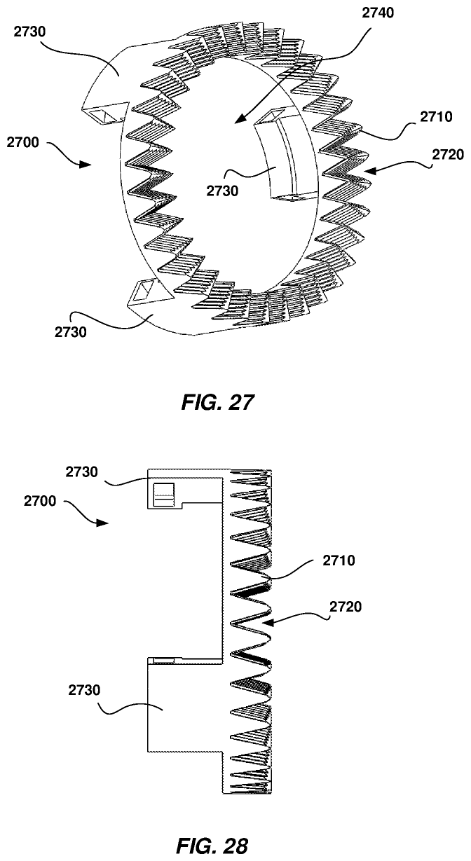

Referring to FIGS. 27 and 28 there is shown an example of a cap attachment 2700 for attaching to the end effector assembly 319. In particular, the cap attachment 2700 has a substantially ring-shaped, annular body having a hole 2740 passing therethrough, wherein the body has teeth 2710 extending from a first surface thereof and legs 2730 protruding from a second opposing surface of the ring-shaped body. The teeth 2710 are triangular shaped thereby defining a cavity 2720 between neighboring teeth 2710. The legs 2710 are resiliently biased for snap lock engagement about the sleeve 950 of the sealable end effector of the end effector assembly. The cap attachment 2700 enables branches or stems connected to the pickable object to be maintained substantially stationary within one of the cavities 2720 defined between neighboring teeth 2710, thereby assisting with the separation of the pickable object from the stationary branch or stem. The cap attachment 2700 has been found useful for picking produce such as oranges to prevent the stem or branch tending to rotate about the perimeter of the sealable end effector. It will be appreciated that in certain dedicated produce picking devices, the cap attachment 2700 may be integrated with the end effector assembly 319 and therefore may not be detachable. In some forms, the teeth 2710 may have a serrated profile or edge to promote separation of the pickable object from the plant.

For picking and conveying pickable produce products, such as fruit, the vacuum device is configured to generate a pressure difference between 50 millibars and 350 millibars. In an additional or alternate form, the vacuum device is configured to generate an airflow of 200 cubic meters per hour to 800 cubic meters per hour.

It will be appreciated that the schematic diagrams of the produce picking device 300 in FIGS. 3 to 5, 12, 12A, 12B, 20, 21 and 22 do not show the conveyor conduit in entirety for clarity so that other portions of the produce picking device 300 are visible. It will be appreciated that the conveyor conduit can have a hose-like appearance.

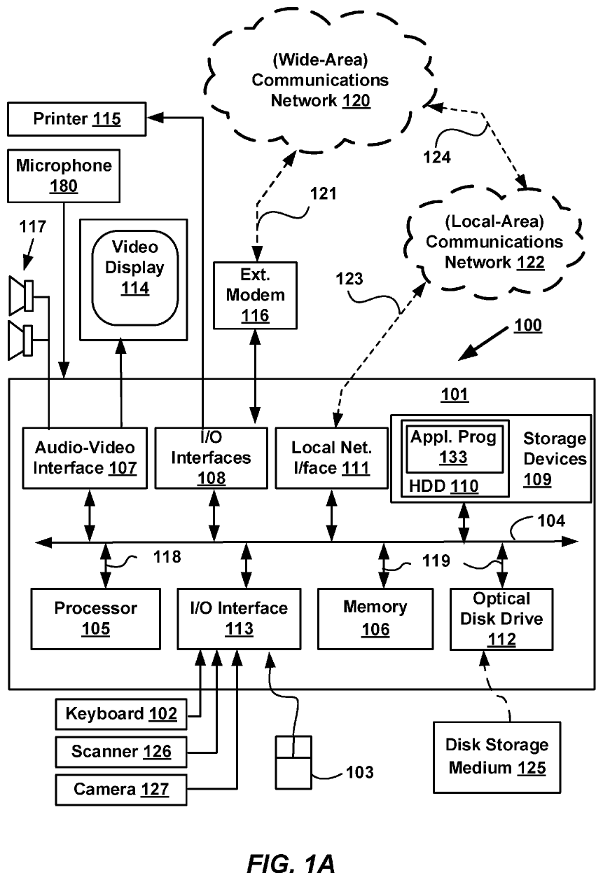

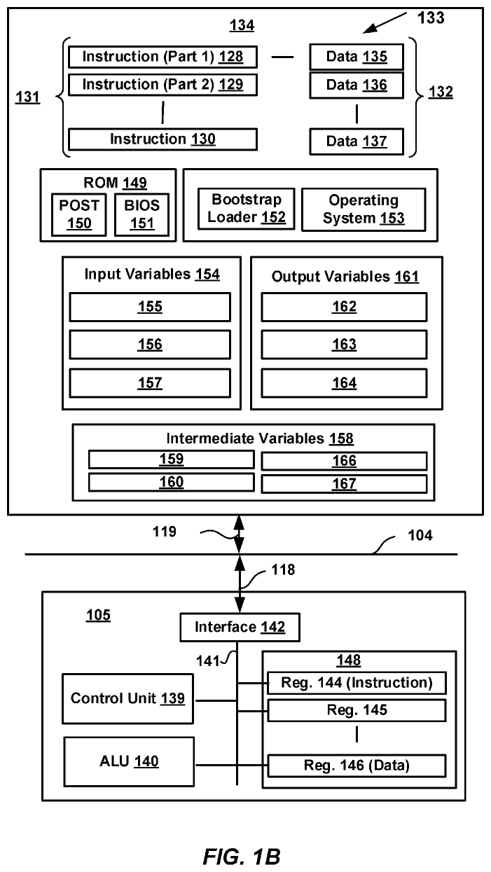

Referring to FIGS. 1A and 1B there is shown a schematic of an example of a general-purpose computer system 100 which can be used for computerized components of the embodiments described above, such as the controller, the remote control device, the training processing system and the portable processing system.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated), or a projector; and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practiced include IBM-PC's and compatibles, Sun Sparcstations, Apple Mac™ or a like computer system.

The methods as described may be implemented using the computer system 100 wherein the processes described herein may be implemented as one or more software application programs 133 executable within the computer system 100. In particular, the steps of the methods described are effected by instructions 131 (see FIG. 1B) in the software 133 that are carried out within the computer system 100. The software instructions 131 may be formed as one or more code modules, each for performing one or more particular tasks.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for detecting and/or sharing writing actions.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from the storage medium 125 inserted into the corresponding reader 112, all depicted in FIG. 1A. The execution of a set of the instructions may in some cases result in output of data. Execution may also involve storing data or variables to the memory 134.

The disclosed writing detection and sharing arrangements use input variables 154, which are stored in the memory 134 in corresponding memory locations 155, 156, 157. The writing detection and sharing arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises: a fetch operation, which fetches or reads an instruction 131 from a memory location 128, 129, 130; a decode operation in which the control unit 139 determines which instruction has been fetched; and an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 162.

Each step or sub-process in the processes described herein are associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The methods described may alternatively be implemented in dedicated hardware such as one or more integrated circuits performing the functions or sub functions of the writing detection and sharing methods. Such dedicated hardware may include graphic processors, digital signal processors, or one or more microprocessors and associated memories.

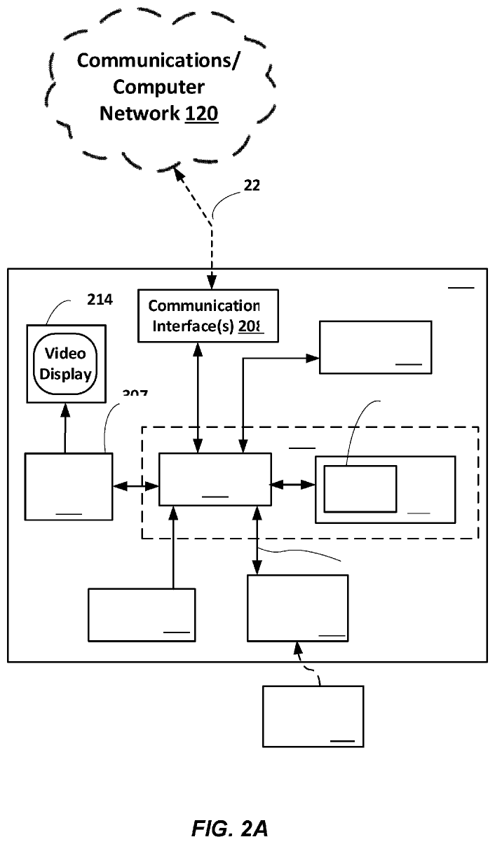

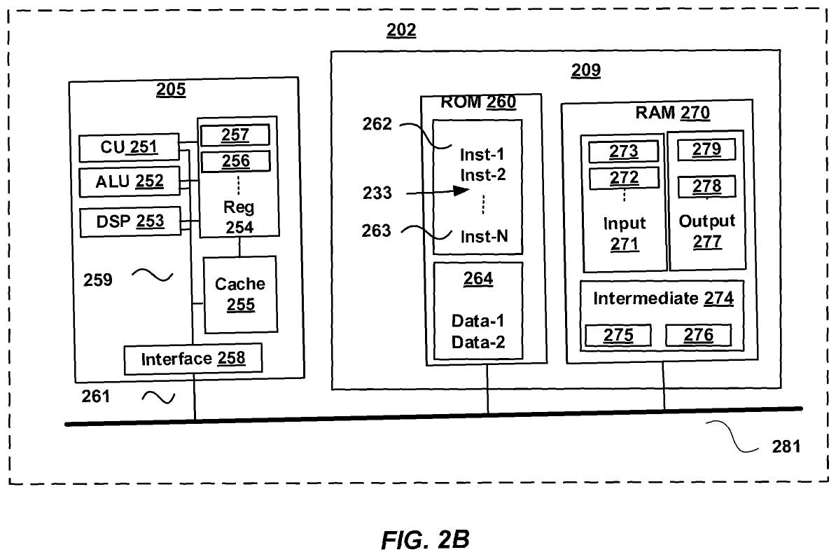

FIGS. 2A and 2B collectively form a schematic block diagram of a general purpose electronic device 201 including embedded components, upon which the writing detection and/or sharing methods to be described are desirably practiced. The electronic device 201 may be, for example, the portable processing system 1420, remote control device 1440 or the controller 1302 of the produce picking device. In some instance, one or more of these devices may be embodied in the form of a mobile phone. Nevertheless, the methods described may also be performed on higher-level devices such as desktop computers, server computers, and other such devices with significantly larger processing resources.

As seen in FIG. 2A, the electronic device 201 comprises an embedded controller 202. Accordingly, the electronic device 201 may be referred to as an “embedded device.” In the present example, the controller 202 has a processing unit (or processor) 205 which is bi-directionally coupled to an internal storage module 209. The storage module 209 may be formed from non-volatile semiconductor read only memory (ROM) 260 and semiconductor random access memory (RAM) 270, as seen in FIG. 2B. The RAM 270 may be volatile, non-volatile or a combination of volatile and non-volatile memory.

The electronic device 201 includes a display controller 207, which is connected to a display 214, such as a liquid crystal display (LCD) panel or the like. The display controller 207 is configured for displaying graphical images on the display 214 in accordance with instructions received from the embedded controller 202, to which the display controller 207 is connected.

The electronic device 201 also includes user input devices 213 which are typically formed by keys, a keypad or like controls. In some implementations, the user input devices 213 may include a touch sensitive panel physically associated with the display 214 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 2A, the electronic device 201 also comprises a portable memory interface 206, which is coupled to the processor 205 via a connection 219. The portable memory interface 206 allows a complementary portable memory device 225 to be coupled to the electronic device 201 to act as a source or destination of data or to supplement the internal storage module 209. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 201 also has a communications interface 208 to permit coupling of the device 201 to a computer or communications network 220 via a connection 221. The connection 221 may be wired or wireless. For example, the connection 221 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 201 is configured to perform some special function. The embedded controller 202, possibly in conjunction with further special function components 210, is provided to perform that special function. For example, where the device 201 is a digital camera, the components 210 may represent a lens, focus control and image sensor of the camera. The special function component 210 is connected to the embedded controller 202. As another example, the device 201 may be a mobile telephone handset. In this instance, the components 210 may represent those components required for communications in a cellular telephone environment. Where the device 201 is a portable device, the special function components 210 may represent a number of encoders and decoders of a type including Joint Photographic Experts Group (JPEG), (Moving Picture Experts Group) MPEG, MPEG-1 Audio Layer 3 (MP3), and the like.

The methods described may be implemented using the embedded controller 202, where the processes described herein may be implemented as one or more software application programs 233 executable within the embedded controller 202. The electronic device 201 of FIG. 2A implements the described methods. In particular, with reference to FIG. 2B, the steps of the described methods are effected by instructions in the software 233 that are carried out within the controller 202. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 233 of the embedded controller 202 is typically stored in the non-volatile ROM 260 of the internal storage module 209. The software 233 stored in the ROM 260 can be updated when required from a computer readable medium. The software 233 can be loaded into and executed by the processor 205. In some instances, the processor 205 may execute software instructions that are located in RAM 270. Software instructions may be loaded into the RAM 270 by the processor 205 initiating a copy of one or more code modules from ROM 260 into RAM 270. Alternatively, the software instructions of one or more code modules may be pre-installed in a non-volatile region of RAM 270 by a manufacturer. After one or more code modules have been located in RAM 270, the processor 205 may execute software instructions of the one or more code modules.

The application program 233 is typically pre-installed and stored in the ROM 260 by a manufacturer, prior to distribution of the electronic device 201. However, in some instances, the application programs 233 may be supplied to the user encoded on one or more CD-ROM (not shown) and read via the portable memory interface 206 of FIG. 2A prior to storage in the internal storage module 209 or in the portable memory 225. In another alternative, the software application program 233 may be read by the processor 205 from the network 220, or loaded into the controller 202 or the portable storage medium 225 from other computer readable media. Computer readable storage media refers to any non-transitory tangible storage medium that participates in providing instructions and/or data to the controller 202 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 201. Examples of transitory or non-tangible computer readable transmission media that may also participate in the provision of software, application programs, instructions and/or data to the device 201 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 233 and the corresponding code modules mentioned above may be executed to implement one or more graphical user interfaces (GUIs) to be rendered or otherwise represented upon the display 214 of FIG. 2A. Through manipulation of the user input device 213 (e.g., the keypad), a user of the device 201 and the application programs 233 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 2B illustrates in detail the embedded controller 202 having the processor 205 for executing the application programs 233 and the internal storage 209. The internal storage 209 comprises read only memory (ROM) 260 and random access memory (RAM) 270. The processor 205 is able to execute the application programs 233 stored in one or both of the connected memories 260 and 270. When the electronic device 201 is initially powered up, a system program resident in the ROM 260 is executed. The application program 233 permanently stored in the ROM 260 is sometimes referred to as “firmware”. Execution of the firmware by the processor 205 may fulfil various functions, including processor management, memory management, device management, storage management and user interface.

The processor 205 typically includes a number of functional modules including a control unit (CU) 251, an arithmetic logic unit (ALU) 252, a digital signal processor (DSP) 253 and a local or internal memory comprising a set of registers 254 which typically contain atomic data elements 256, 257, along with internal buffer or cache memory 255. One or more internal buses 259 interconnect these functional modules. The processor 205 typically also has one or more interfaces 258 for communicating with external devices via system bus 281, using a connection 261.

The application program 233 includes a sequence of instructions 262 through 263 that may include conditional branch and loop instructions. The program 233 may also include data, which is used in execution of the program 233. This data may be stored as part of the instruction or in a separate location 264 within the ROM 260 or RAM 270.

In general, the processor 205 is given a set of instructions, which are executed therein. This set of instructions may be organised into blocks, which perform specific tasks or handle specific events that occur in the electronic device 201. Typically, the application program 233 waits for events and subsequently executes the block of code associated with that event. Events may be triggered in response to input from a user, via the user input devices 213 of FIG. 2A, as detected by the processor 205. Events may also be triggered in response to other sensors and interfaces in the electronic device 201.

The execution of a set of the instructions may require numeric variables to be read and modified. Such numeric variables are stored in the RAM 270. The disclosed method uses input variables 271 that are stored in known locations 272, 273 in the memory 270. The input variables 271 are processed to produce output variables 277 that are stored in known locations 278, 279 in the memory 270. Intermediate variables 274 may be stored in additional memory locations in locations 275, 276 of the memory 270. Alternatively, some intermediate variables may only exist in the registers 254 of the processor 205.

The execution of a sequence of instructions is achieved in the processor 205 by repeated application of a fetch-execute cycle. The control unit 251 of the processor 205 maintains a register called the program counter, which contains the address in ROM 260 or RAM 270 of the next instruction to be executed. At the start of the fetch execute cycle, the contents of the memory address indexed by the program counter is loaded into the control unit 251. The instruction thus loaded controls the subsequent operation of the processor 205, causing for example, data to be loaded from ROM memory 260 into processor registers 254, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described is associated with one or more segments of the application program 233, and is performed by repeated execution of a fetch-execute cycle in the processor 205 or similar programmatic operation of other independent processor blocks in the electronic device 201.

Non-limiting advantages of the produce picking device 300 will now be discussed.

As discussed above, the substantially equal distribution of the deformable lips 457 between the first end and the exit aperture allow for the picked object to be incrementally conveyed between neighboring lips 457, thereby controlling the movement of the object within the conveyor conduit 467. The deformable lips 457 inhibit the momentum of the pickable object under force exerted by the vacuum device, thereby avoiding the momentum of the object to increase to a level which could cause the produce object to bruise in a collision with a hard surface. Furthermore, the deformable lips 457 help cushion and support the transfer of the object between neighboring lips 457, thereby carefully controlling the conveyance of the produce object along the conveyance conduit. It will be appreciated that the incremental conveyance of the object along the conveyor conduit 467 refers to the cyclic increase and decrease in instantaneous velocity of the pickable object within the conveyor conduit 467 as it successively comes into contact with each deformable lip 457 of the conveyor conduit 467. As the pickable object passes through one of the deformable lips 457 thereby increasing in speed momentarily, the pickable object comes into contact with and is cushioned by the next deformable lip 457 under the force exerted by the vacuum device, thereby momentarily inhibiting the increase in momentum of the produce object which could lead to damage.

Because the sealable picking effector 449 uses an aperture 453 with a deformable lip 457, the vacuum motor requires substantially less power to pick the pickable object 455 from the plant. Further, as shown in FIG. 7A to 7C, because the pickable object 455 experiences insubstantial forces until it is in engagement with the entry aperture 453, the forces created, for example on the stem of an apple, are perpendicular to the stem and cause a clean fracture of the stem, as opposed to if the apple had been experiencing forces toward the conveyor 467 therefore leaning toward the conveyor 467, causing the forces to be parallel to the stem.

Because the conveyor 467 has a plurality of second chambers 465, the pickable object 455 is substantially at all times in contact with the relatively soft deformable lips 457, decreasing damage to the pickable object 455 that may have otherwise been caused by contact with the interior wall 459.

Because the second chambers 465 include stiffeners 471, the overall resilience to damage and puncture of the conveyor 467 is improved. Because the interior wall 459 of the second chambers 465 is discontinuous, the conveyor 467 is more flexible and pliable.

Because the entry aperture 453 and deformable lips 457 are dimensioned to conform with a minimal and maximal expected cross-section of the pickable object 455, respectively, a large proportion of pickable objects 455 create the desired seal over the aperture 453, but are also able to traverse the aperture 453 through the deformable lips 457. The acute angle formed by the frustoconical deformable lips 457 facilitates movement of the pickable object 455 through the aperture 453.

Because the end effector assemblies 319 are movable with a common drive such that vertical movement of one end effector assembly 310 coincides with an inverse vertical movement of another end effector assembly 319, the first robotic actuator 325 has to overcome less, or none, of the weight of the end effector assemblies 319.

Because the chain drives effecting movement of the end effector assemblies 319 along the first and fourth axes 323, 443 are differentially drivable, so as to change an angle between the sealable picking effector 449 and the first or fourth axis 332, 443, the pickable object 455 on the plant may be approached from a large variety of different angles. This is even further improved by the movement of the rotating platform 441 about the fifth axis 473.

Because the sensor for assessing the pickable object 455 after picking is located at the end of the conveyor 467, the conveyor 467 may act as a buffer reservoir, such that the sealable picking effector 449 may operate faster that the bin assembly 305 or the sensor for assessing in one period, but slower in another period, for example when moving to a new plant.

Because the platform assembly 479 is movable in response to the fill signal, the drop distance of the pickable object 455 from the conveyor 467 to the floor 499 of the bin 487 may be minimised when the bin 487 is empty. Because the platform assembly 479 is movable in response to the fill level increasing toward the threshold fill level, the movement of the bin 487 relative to the conveyor 467 may be smoother. Because the movement of the platform assembly 479 may be based on a predetermined function of the fill signal, the distance between the drop distance of the pickable object 455 from the conveyor 467 to the current fill level may be kept within a predetermined acceptable range to reduce damage to the pickable object 455.

Because the pulley 489 is located vertically above the roller bracket 481, the forces imparted on the roller bracket 481 are substantially parallel to the upright 483, reducing damage to the platform assembly 479 and the upright 483.

Because the alternative embodiment of FIGS. 12A and 12B has a box lattice structure for the cantilever 491 and upright 475 of the bin assembly 305, and a rectangular elongate frame 307 for the picking assembly 303, the torsional and flexural rigidity of the assemblies 303, 305 is improved. This is particularly advantageous to reduce vibrations in the structure to improve the steerability of the end effector assemblies 319 towards the pickable object 455.

Whilst the produce picking device, method and system have been described with example references to picking apples, the disclosed produce picking device can be used for a variety of substantially spherically shaped produce. For example, oranges, mandarins, and plums are examples of produce which can be picked using the disclosed produce picking device.

Although the invention has been described with reference to one or more preferred embodiments, it will be appreciated by those skilled in the art that the invention may be embodied in other forms.

The advantageous embodiments and/or further developments of the above disclosure—except for example in cases of clear dependencies or inconsistent alternatives—can be applied individually or also in arbitrary combinations with one another.

1.-34. (canceled)

35. A conveyor conduit for receiving a pickable object and conveying the pickable object, wherein the conveyor conduit comprises:
a first end including a sealable picking effector, wherein the sealable picking effector includes an entry aperture for receiving the pickable object;
an exit aperture;
a plurality of deformable lips that are substantially equally distributed between the first end and the exit aperture; and
a vacuum device in fluid communication with the first end such that when the pickable object is received by the first end, the pickable object is incrementally conveyed and supported in a conveying direction from the entry aperture to the exit aperture by the plurality of deformable lips.

36. The conveyor conduit of claim 35, wherein the entry aperture is surrounded by an entry deformable lip, which includes a frustroconical projection from an interior wall of the entry aperture, the projection forming an acute angle in the conveying direction.

37. The conveyor conduit of claim 35, wherein the conveyor conduit includes a plurality of conduit segments which are coupled together and define a plurality of chambers, and wherein each chamber is separate from an adjacent chamber by an aperture.

38. The conveyor conduit of claim 37, wherein the aperture is dimensioned to conform to a minimal expected cross-section of the pickable object.

39. The conveyor conduit of claim 37, wherein each conduit segment includes a sleeve extending rearwardly from the respective deformable lip.

40. The conveyor conduit of claim 39, wherein each conduit segment includes:
a tail portion of the sleeve; and
a stiffener located adjacent to and located within the respective sleeve; wherein the tail portion of one conduit segment couples about and sealingly engages with the sleeve supported by the respective stiffener of a rearwardly neighboring conduit segment.

41. The conveyor conduit of claim 40, wherein each conduit segment is formed from an elastic material, such that the tail portion is stretchable over an outer surface of the sleeve of the rearwardly neighboring conduit segment to couple the conduit segments together.

42. The conveyor conduit of claim 40, wherein the tail portion includes a fastener to connect adjacent conduit segments.

43. The conveyor conduit of claim 40, wherein the stiffener includes a hollow cylinder formed from a material having higher stiffness than a material of the respective conduit segment.

44. The conveyor conduit of claim 40, wherein the stiffener is dimensioned to have a second moment of area that is higher than the respective conduit segment to resist buckling of an interior wall of the respective conduit segment.

45. The conveyor conduit of claim 37, wherein an interior wall of each second chamber is discontinuous to facilitate relative movement of the second chambers.

46. The conveyor conduit of claim 35, wherein a spacing between the plurality of deformable lips is between 10 mm to 100 mm.

47. The conveyor conduit of claim 35, wherein the exit aperture is located between the vacuum device and the entry aperture.

48. The conveyor conduit of claim 47, wherein the exit aperture is covered with an openable door, the openable door being openable by the pickable object under a gravity force and/or a vacuum force exerted by the vacuum device.

49. The conveyor conduit of claim 35, wherein a portion of the plurality of deformable lips proximate the exit aperture are thicker in cross-section than the deformable lips located distally relative to the exit aperture, to reduce a velocity of the pickable object proximate the exit aperture.

50. The conveyor conduit of claim 35, wherein the vacuum device is configured to generate a pressure difference between 50 millibars and 350 millibars.

51. The conveyor conduit of claim 35, wherein the vacuum device is configured to generate an airflow of 200 cubic meters per hour to 800 cubic meters per hour.
